(19) United States
(12) Patent Application Publication
(10) Pub. No.: US 2026/0119929 A1
(43) Pub. Date: Apr. 30, 2026

(54) Method, System and Computer Program for Simulating a Measurement-Based Quantum Computation on a Classical Computer

(71) Applicant: IHSAN DOGRAMACI BILKENT ÜNIVERSITESI, Çankaya/Ankara (TR)

(72) Inventors: Cihan OKAY, Çankaya/Ankara (TR); Selman IPEK, Çankaya/Ankara (TR); Atak Talay YÜCEL, Çankaya/Ankara (TR)

(21) Appl. No.: 18/925,447

(22) Filed: Oct. 24, 2024

(51) Int. Cl. G06N 10/20

(52) U.S. Cl. CPC G06N 10/20

(57) ABSTRACT

A method of simulating a measurement-based quantum computation, including an application of a sequence of J≥1 steps of Pauli measurements to an entangled resource state of a plurality of n qudits on a classical computer, the qudits being quantum mechanical d-level systems, d≥2. The method includes using a computational key that is indicative of at least one initial sample from a probability distribution that is associated with the resource state and is defined on an initial set of operators of an initial polytope of trace-one Hermitian operators on a Hilbert space associated with the plurality of qudits. The initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero. The local stabilizer states are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

The present invention is related to a method for simulating a measurement-based quantum computation on a classical computer.

The invention is further related to a method for generating a computational key by a key generation computer and to a system for simulating the measurement-based quantum computation, the system comprising a classical computer and the key generation computer. Furthermore, the invention is related to a computer program product for simulating the measurement-based quantum computation on the classical computer and to a storage medium having stored thereon the computer program product. Even further, the invention is related to a computer program product for generating the computational key and to a storage medium having stored thereon the computer program product.

Quantum computation is a field of computation wherein quantum mechanical d-level systems, so-called qudits, d≥2, are the carriers of information, and the computation makes use of the physical laws of quantum mechanics. The most prominent example of a qudit is a qubit which has d=2 levels. Physical realizations of qubits include superconducting qubits, ions, photons, atoms, etc. During the computation, the qudits may be in a highly complex state which has properties without a classical counterpart and that are described by the quantum mechanical concepts of superposition and entanglement. Classical computation, on the other hand, is based on the manipulation of classical bits which take discrete values, often called “0” and “1”. It is proven that quantum computers may, in theory, solve computational problems much faster than any classical computer, a property which is also known as quantum supremacy.

There exist several models of quantum computation. A prominent one is the quantum circuit model where a sequence of quantum gates is applied to a plurality of qubits that are prepared in an initial state which is in general a product state and therefore easy to prepare. At the end, a quantum measurement is applied to the final state of the qubits. The measurement outcome is in general indicative of the solution of a computational problem.

Another model of quantum computation is measurement-based quantum computation. There, the qudits are prepared in an entangled resource state, and a sequence of measurements is applied to the qudits. The final measurement of the qudits results in a measurement outcome that is in general indicative of the solution of a computational problem.

The quantum circuit model and the measurement-based quantum computation model are equivalent as there exists a mapping between them.

While quantum computing is a very promising idea in theory, its practical realization in physical systems of qubits or qudits with d>2 faces many problems despite tremendous effort in this field.

One alternative approach for solving complex computational problems is to develop methods for simulating quantum computation on a classical computer. It has been shown in V. Veicht et. al, “Negative quasi-probability as a resource for quantum computation”, New Journal of Physics 14, 113011 (2012) that quantum computation can be represented by quasi-probability distributions that also admit negative values. The negative values render the simulation exponentially hard. In this simulation method quantum computation is provided in the magic state model, an alternative computational scheme to the quantum circuit model.

An approach for simulating quantum computation on a classical computer by use of a positive probability distribution is proposed in US 2023/026102 A1. The quantum computation to be simulated comprises an application of a sequence of adaptive Pauli measurements to an initial magic state. The simulation is based on a classical computational key which comprises only classical information and which is generated in advance by a classical supercomputer or a quantum computer, and an application of a sequence of update rules to the computational key. While the simulation method proposed in US 2023/026102 A1 is very promising, the generation of the computational key and the simulation are computationally costly.

Due to these problems in the prior art, it is therefore an object of the present invention to provide a method for classical simulation of quantum computation which may be implemented more efficiently.

According to a first aspect of the present invention, there is provided a method of simulating a measurement-based quantum computation comprising an application of a sequence of J≥1 steps of Pauli measurements to an entangled resource state of a plurality of n qudits on a classical computer, the qudits being quantum mechanical d-level systems, d≥2, the method comprising use of a computational key that is indicative of at least one initial sample from a probability distribution that is associated with the resource state and is defined on an initial set of operators of an initial polytope of trace-one Hermitian operators on a Hilbert space associated with the plurality of qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

The computational scheme of choice of the present invention is yet another model known as measurement-based quantum computation.

A qudit is a quantum mechanical d-level system with d≥2. For the case d=2, the qudit is a qubit. Within the theoretical framework of quantum computation, a Hilbert space [symbol] may be associated with each qudit. A basis of the single-qudit Hilbert space may be formed by d basis states |k [symbol] , k=0 . . . , d−1. The state of a single qudit may be described by a superposition of the basis states, i.e.,

$${\sum }_{k = 0}^{d - 1} {c}_{k} \vert k 〉$$

with complex coefficients cₖ, wherein

$${\sum }_{k = 0}^{d - 1} {\vert {c}_{k} \vert}^{2} = 1.$$

For n qudits, a Hilbert space which is an n-fold tensor product of the single-qudit Hilbert space may be associated therewith. The state of the n qudits may be described by a linear combination of dⁿ basis states |k₁, k₂ . . . , kₙ [symbol] , wherein kᵢ∈{0,1, . . . , d−1}. |k₁, k₂, . . . , k [symbol] is to be understood as a short hand notation for a tensor product of n single-qudit basis states |kᵢ [symbol] , i.e., |k₁, k₂, . . . kₙ [symbol] =|k₁ [symbol] ⊗|k₂ [symbol] ⊗ . . . ⊗|kₙ [symbol] The system of the n qudits may be in a pure state or in a mixed state which is a probabilistic mixture of the pure quantum states.

The resource state is an entangled state of the n qudits. The concept of entanglement is well-known in the field of quantum computation. In particular, an entangled state is not separable and thereby has quantum correlations which do not have a classical counterpart. In one example, the resource state may be a pure state of the n qudits. In another example, the resource state may be a mixed state of the n qudits.

A Pauli measurement of the n qudits may be understood as a measurement of an n-qudit Pauli operator on the n qudits. The n-qudit Pauli operator is an element of the n-qudit Pauli group. The Pauli operator may have a non-trivial action on at least one qudit. The n-qudit Pauli group is a subgroup of the unitary group U(dⁿ). For d=2, the n-qubit Pauli group is generated by products and tensor products of

$$X = {\sum }_{k = 0}^{1} \vert k + 1 〉 〈 k \vert$$

### (Pauli X-operator) and

$$Z = {\sum }_{k = 0}^{1} {( - 1 )}^{k} \vert k 〉 〈 k \vert$$

(Pauli Z-operator). Analogous definitions exist for qudits with d>2. The measurement outcomes of a Pauli measurement are the possible eigenvalues of the Pauli operator. Every Pauli operator on the n qubits may be written as Tₐ=i^{a}^{_{X}}^{·a}^{_{Z}}X^{(a}^{_{X}}⁾^{₁}Z^{(a}^{_{Z}}⁾^{₁}⊗ . . . ⊗X^{(a}^{_{X}}⁾^{ₙ}Z^{(a}^{_{Z}}⁾^{ₙ}, wherein a∈

$$a ∈ {E}_{n} = {ℤ}_{2}^{n} \times {ℤ}_{2}^{n} and {a}_{X} \cdot {a}_{Z}$$

denotes the dot product of the bit strings. For qubits, the quantum measurement of the Pauli operator Tₐ may be described by a projector

$${Π}_{a}^{s} = ( + {( - 1 )}^{s} {T}_{a} ) / 2 onto the {( - 1 )}^{s} eigenspace , s ∈ \{ 0 , 1 \} .$$

The measurement-based quantum computation to be simulated comprises an application of a sequence of J≥1 steps of Pauli measurements to the entangled resource state. I.e., the measurement-based quantum computation comprises an application of a first Pauli measurement, followed by a second, third, fourth, . . . , J-th Pauli measurement. The Pauli measurements may be adaptive measurements in one example. I.e., the Pauli measurement to be applied in the j-th step depends on the measurement outcome of the previous measurement or measurements.

In one example, the method of the present invention may be applied to solve a computational problem. In one example, the computational problem may already be in the form of a measurement-based quantum computation specifying the initial resource state and the sequence of J Pauli measurements. In another example, the computational problem may be in the form of the quantum circuit model, i.e., it may comprise a description of an initial state, a plurality of quantum gates and a final quantum measurement. In this case, the method of the present invention may further comprise mapping the quantum circuit model description of the computational problem to its measurement-based quantum computation description specifying the initial resource state and the sequence of quantum measurements applied thereto, wherein some of the quantum measurements may be adaptive quantum measurements. The mapping may be carried out by the classical computer in one example.

The computational key is indicative of at least one initial sample from the probability distribution that is associated with the resource state and is defined on an initial set of operators of an initial polytope of trace-one Hermitian operators on a Hilbert space associated with the plurality of qudits. In one example, the computational key may comprise the at least one sample. In another example, the computational key may comprise instructions for generating the at least one sample. In one example, the computational key may comprise the probability distribution. In particular, the computational key may comprise only classical information, e.g., classical bits. The sample is one of the operators of the initial set of operators.

In one example, the computational key may comprise only one sample. This is particularly favorable when the quantum computation to be simulated is deterministic. When the quantum computation is not deterministic, it is favorable that the computational key comprises more than one sample. The accuracy of the simulation may then depend on the number of samples.

The initial polytope is a local n-qudit polytope specified by the number n of qudits. I.e., for every natural number n there is a different initial polytope associated with the plurality of n qudits. The local n-qudit polytope is a special set of trace-one Hermitian operators on the Hilbert space associated with the plurality of n qudits. To be precise, the n-qudit polytope is the set of those Hermitian trace-one operators A∈Herm₁( [symbol] ) on the Hilbert space [symbol] associated with the plurality of n qudits having the property that for each local stabilizer state |ψ [symbol] of the plurality of qudits a trace of a product of the Hermitian operator A and a density operator |ψ [symbol] ψ| of the local stabilizer state is equal to or larger than zero. I.e., if we denote by

$${S}_{n}^{l}$$

the set or n-quant local stabilizer states, the local n-qudit polytope

$${Λ}_{n}^{l}$$

is defined as

$${Λ}_{n}^{ℓ} = \{ A ∈ {Herm}_{1} ( ℋ ) : Tr ( \vert ψ 〉 〈 ψ \vert A ) \geq 0 , ∀ \vert ψ 〉 ∈ {S}_{n}^{l} \} .$$

Within this specification, the local n-qudit polytope

$${Λ}_{n}^{l}$$

is also called the local Λ-polytope. The local n-qudit polytope may also be understood as the dual of the polytope of the local stabilizer states. A quantum state is a stabilizer state if it is of the form U|0 . . . 0 [symbol] , wherein |0 . . . 0 [symbol] is an n-qudit state and U is some Clifford unitary acting as the n qudits. Throughout this specification, the set of n-qudit stabilizer states is denoted as Sₙ. The local Clifford group is the subgroup of the n-qudit Clifford group generated by the single qudit Clifford unitaries acting on each tensor factor, i.e., U=U₁⊗ . . . ⊗Uₙ, wherein Uₖ is a Clifford unitary acting on the k-th qudit. If we define by H the subgroup generated by the local Clifford group and the unitaries U_{π} that permute the tensor factors. U_{π}|k₁, k₂ . . . kₙ [symbol] =|k_{π(1)}, k_{π(2)} . . . k_{π(n)} [symbol] , wherein π is a permutation of the set {1, . . . , n}, the local stabilizer states are those stabilizer states U|00 . . . 0 [symbol] , where U is in the subgroup H.

The initial set of operators comprises a plurality of operators of the local n-qudit polytope.

In one example, the computational key may have been stored on a storage medium, e.g., in a data base and the method may comprise retrieving the computational key from the storage medium.

As will be shown below for the case of qubits, the local n-qudit polytope is identical to the non-signaling polytope of the n-partite Bell scenario with 3 dichotomic measurements per party, which also generalizes to qudits with d>2.

Compared to the polytope used for the simulation disclosed in US 2023/026102 A1, the local n-qudit polytope of the present invention has a simpler structure and therefore allows for a more efficient generation of the computational key and for a more efficient execution of the simulation method on the classical computer as will be specified in more detail below.

In particular, certain extreme points of the n-qubit local polytope have a tensor product structure. Namely, if A_{α} is an extreme point of a local n₁-qudit polytope and A_{β} is an extreme point of a local n₂-qudit polytope, then A_{α}⊗A_{β} is an extreme point of a local (n₁+n₂)-qudit polytope. This tensor product structure may render the simulation more efficient.

The classical computer may be configured in a wide variety of ways, as long as it processes classical bits of information. In one example, the classical computer may comprise a microprocessor. The classical computer may comprise a general purpose computer, a server computer, a cloud computer, a mainframe computer, a computer workstation, and the like in one example. The classical computer may comprise a CPU in one example. In one example, the classical computer may comprise logic circuits, application-specific integrated circuits (“ASICs”), large scale integrated circuits (“LSIs”), very large scale integrated circuits (“VLSIs”), programmable array logic (“PALs”), programmable logic arrays (“PLAs”), and field programmable gate arrays (“FPGAs”).

According to one embodiment of the method according to the first aspect of the present invention the qudits may be qubits. This embodiment is of high relevance as many quantum algorithms are formulated for qubits. Below, technical results are presented for qubits. However, it may easily be understood for the person skilled in the art that these results apply to qudits as well.

In one further embodiment of the method according to the first aspect of the present invention, the resource state may be a magic Cluster state described by a state parameter specifying a graph G of n vertices, each being associated with one qudit, and a plurality of edges, and a subset U_{V} of the vertices, the resource state having a state vector representation in which a product state of the n qudits, those of which correspond to the vertices of the subset of vertices, are in a magic state, is entangled by an entangling operation specified by the edges of the graph. If one denotes by V={1, . . . n} the vertex set of the graph, by U_{V}⊆V the subset of the vertices and by E the set of edges of the graph, wherein an edge eᵢⱼ connects the vertices i and j, the state vector representation of the initial resource state may be

$${\vert {ψ}_{G , {U}_{V}} 〉 = E ( G ) {T}^{⊗ {U}_{V}} \vert + 〉}^{⊗ n}$$

For qubits, the initial resource state |ψ_{G,U}_{_{V}} [symbol] may be obtained by first preparing each of the n qubits in the state

$$\vert + 〉 = \frac{1}{\sqrt{2}} ( \vert 0 〉 + \vert 1 〉 )$$

which is the +1 eigenstate of the Pauli X-operator. Each of the n qubits is associated with one of the n vertices of the graph and vice versa. Then, a T-gate is applied to those qubits which are associated with the vertices of the subset U_{V} of the vertex set V. This is described by the operator T^{⊗U}^{_{V}} above. The T-gate is of the form

$$T = \vert 0 〉 〈 0 \vert + {e}^{\frac{i π}{4}} \vert 1 〉 〈 1 \vert .$$

In this way, the qubits associated with the vertices of the subset U_{V} are prepared in a magic state. The magic state of a qubit may be described by the state vector

$$( \vert 0 〉 + {e}^{\frac{i π}{4}} \vert 1 〉 ) / \sqrt{2} .$$

In particular, the subset U_{V} may be a non-empty set in one example. In another example, the subset of vertices U_{V} may be the set of all vertices of the graph G. Finally, an entangling operation E(G) specified by the edges eᵢⱼ∈ E is applied to the qubits. In one example a two-qubit entangling gate is applied to each pair of qubits corresponding to the edges of the graph. I.e., E(G)=⊗_{i,j:e}_{ᵢⱼ}_{∈E}Eᵢⱼ, wherein Eᵢⱼ is a two-qubit entangling gate between qubit i and qubit j. In one example, at least one of the two-qubit entangling gates Eᵢⱼ is a controlled-Z or a controlled-NOT gate. In one example, every two-qubit entangling gate Eᵢⱼ is a controlled-Z or a controlled-NOT gate. However, the invention is not limited to this. The magic Cluster state for qudits with d>2 may be obtained in a similar way.

As will be further explained below, a resource state which is a magic Cluster state may allow for universal measurement-based quantum computation. Therefore, a simulation of measurement-based quantum computing based on magic Cluster states is of high relevance.

In one example, the state parameter may comprise the graph G and the subset of the vertices U_{V}. In particular, the state parameter may comprise a representation of the graph G by the set V of vertices and the set E of edges, and the subset U_{V} of vertices. In one example, the state parameter may further comprise a specification of the two-qubit entangling operation applied to each qudit.

According to another embodiment of the method according to the first aspect of the present invention, the method may comprise a simulation of the application of the J steps of Pauli measurements by a corresponding sequence of J update maps, wherein starting from the at least one initial sample of the computational key as an input of a first update map of the sequence of update maps, an output of a preceding update map is a basis of an input of a subsequent update map, wherein the output of each map is indicative of an operator of an output polytope which is a local nₒᵤₜ-qudit polytope specified by an output number nₒᵤₜ of qudits which is equal or less than the number n of qudits. In one example, the output of the preceding update map is the input of the subsequent update map. However, the invention is not limited to this. In particular, the j-th update map may correspond to the j-th Pauli measurement.

When the computational key is indicative of more than one initial sample, the sequence of J update maps may be applied to each of the samples. I.e., for each of the initial samples, the method comprises starting from the initial sample as the input of the first update map, and the output of the preceding update map is the basis of the input of the subsequent update map. Then, a final result of the simulation may be obtained for each initial sample on the basis of the outcomes of the application of the sequence of update maps to the sample. In one example, the final result of the simulation may be obtained by averaging over the results obtained for the different samples.

The initial sample is an operator of the initial set of operators of the local n-qudit polytope. In one example, the operators of the initial set of operators and the operators of the output polytope may have a classical representation. I.e., the operators may be described by a bit or bit string in one example. For example, each operator in the initial set of operators may be associated with a label that has a representation as a bit or bit string. In this case, it may be understood that the method according to the present invention comprises starting from the classical representation of the at least one initial sample by an initial bit or bit string as the input of the first update map and the output of the preceding update map is an output bit or bit string which is representative of the output operator and which is a basis of the input of the subsequent update map. Thereby, the quantum computation may be simulated by operations on classical bits or bit strings. This may allow for a very efficient implementation of the simulation on the classical computer.

The output of each map is indicative of an operator of an output polytope. Thus, one may associate an output polytope with each update map, and one may also associate an input polytope with each update map, wherein starting from the initial polytope as the input polytope associated with the first update map, the output polytope associated with the preceding update map may be indicative of the input polytope associated with the subsequent update map. In one example, the input polytope associated with the subsequent update map may be the output polytope associated with the preceding update map. In one example, each input polytope and each output polytope may be a local N-qudit polytope, wherein N is at most the number n of qubits.

When the j-th update map corresponds to a j-th Pauli measurement which is a non-destructive measurement, the output polytope may be identical to the input polytope in one example. When the j-th update map corresponds to a j-th Pauli measurement which is a destructive measurement, the output polytope may be specified by a number nₒᵤₜ of qudits which is less than the number of qudits specifying the input polytope.

The action of the update maps may be determined in advance before the method according to the present invention is implemented. In another example, the method according to the present invention may further comprise determining the action of each update map for the possible input operators. This may be carried out, e.g., by the classical computer.

When the Pauli measurements are adaptive Pauli measurements (i.e., the subsequent Pauli map depends on the outcome of the preceding Pauli measurement or measurements), the update maps may be adaptive update maps. I.e., the subsequent update map depends on the outcome of the preceding update map or maps.

As will be explained in more detail below, the method according to the present invention may allow for an implementation of the update maps which is more efficient than in the method disclosed in US 2023/026102 A1.

In one embodiment of the method according to the first aspect of the present invention, the Pauli measurements may be single-qudit Pauli measurements. The single-qudit Pauli measurements have corresponding update maps which may be very efficiently implemented on the classical computer. In one embodiment, the single-qudit Pauli measurements may be measurements of the Pauli-X and Pauli-Y operators. However, the invention is not limited to this. For example, the single-qudit Pauli measurement may also be a Pauli-Z measurement in certain examples. A measurement-based quantum computation which comprises an application of the single-qudit measurements to the initial magic Cluster state introduced above is denoted as measurement-based Pauli computation model (MBPC) within this specification. As it is shown below, the local n-qudit polytope is the largest polytope contained in Herm₁( [symbol] ) which is preserved by all single-qudit Pauli measurements. Therefore, the method according to the present invention may reliably simulate the MBPC model.

In one embodiment of the method according to the first aspect of the present invention, the initial set of operators may comprise at least one extreme point of the initial polytope. An extreme point of the polytope may also be called a “vertex” within this specification. The action of an update map may have a particularly simple form for a vertex.

In one embodiment of the method according to the first aspect of the present invention, the initial set of operators may comprise at least one operator which is a locally closed operator defined by the property that its expectation values with respect to a locally closed subset of Pauli operators are the d-th roots of unity, and zero otherwise, wherein a locally closed subset is a subset of Pauli operators such that the product of any pair of locally commuting Pauli operators, i.e., those operators for which all tensor factors commute, belongs to the set. I.e., when the Paul operators P₁⊗P₂⊗ . . . ⊗Pₙ and \tilde{P}₁⊗P₂⊗ . . . ⊗\tilde{P}ₙ, wherein Pⱼ and \tilde{P}ⱼ are single-qudit Pauli operators (for qubits, the single-qudit Pauli operators are the Pauli-X operator, the Pauli-Y operator, the Pauli-Z operator or the identity operator [symbol] ), are in the locally closed subset, and when Pⱼ and \tilde{P}ⱼ commute for each j=1, . . . , n. i.e., Pⱼ\tilde{P}₁−\tilde{P}ⱼPⱼ=0, then the operator Pⱼ\tilde{P}ⱼ also belongs to the locally closed subset. Below, locally closed sets of operators are discussed in more detail using a phase space representation.

In one embodiment of the method according to the first aspect of the present invention, the initial set of operators may comprise at least one operator which is a tensor product of k ≥ 1 operators, each operator being an operator of a local nᵢ-qudit polytope such that n₁+n₂+ . . . +nₖ=n. Within this specification, a tensor product of k ≥1 operators includes for k=1 the case of a single operator, without any tensor product structure. As it is explained in more detail below, a tensor product of a vertex of a local nᵢ-qudit polytope and a vertex of a local nⱼ-qudit polytope is a vertex of a local (nᵢ+nⱼ)-qudit polytope.

In one embodiment of the method according to the first aspect of the present invention, the tensor factors are locally closed operators, which are either an extreme point of a local single-qudit polytope or, in the case of qubits, a max-weight nᵢ-qubit type defined by the property that its expectation values with respect to those Pauli operators for which each tensor factor is non-trivial, is +1 or −1, and zero otherwise. The tensor factors of a Pauli operator are non-trivial when they are different from the identity operator [symbol] . I.e., for qubits these Pauli operators are of the form P₁⊗ & P₂ ⊗ . . . ⊗Pₙ where each single-qubit Pauli operator Pⱼ is a Pauli-X, a Pauli-Y or a Pauli-Z operator. Just to be entirely clear, the embodiment includes that in the case of qubits the tensor factors may be locally closed operators which are an extreme point of a local single-qubit polytope or a max-weight nᵢ qubit type. For qudits with d>2, the tensor factors may be locally closed operators which are extreme points of a local single-qudit polytope.

When all tensor factors are an extreme point of the local single-qudit polytope, the operator may be of the form A=A₁⊗ . . . ⊗Aₙ, wherein each tensor factor Aᵢ, i=1, . . . , n is a vertex of the local single-qudit polytope. In the case of qubits, A_{(\vec{a},\vec{b},\vec{c})}=Aₐ_{₁}_{b}_{₁}_{c}_{₁}⊗Aₐ_{₂}_{b}_{₂}_{c}_{₂}⊗ . . . ⊗Aₐ_{ₙ}_{b}_{ₙ}_{c}_{ₙ} wherein Aₐ_{ᵢ}_{b}_{ᵢ}_{c}_{ᵢ} is a vertex of the local single-qubit polytope with

$${A}_{abc} = \frac{1}{2} ( + {( - 1 )}^{a} X + {( - 1 )}^{b} Y + {( - 1 )}^{c} Z ) ,$$

a, b, c, E {0,1}, and wherein X, Y, Z are the Pauli-X, Pauli-Y and Pauli-Z operators, respectively.

In one embodiment of the method according to the first aspect of the present invention, the output of the update map may be indicative of an extreme point of the output polytope. In one example, each update map may map a vertex of the associated input polytope to a vertex of the associated output polytope. This update of the vertices may allow for a particularly efficient simulation of the measurement-based quantum computation on the classical computer.

According to a further expedient embodiment of the method according to the first aspect of the present invention, starting from the at least one initial sample the output of each update map may be indicative of a sample from an update map probability distribution associated with the corresponding Pauli measurement, the update map probability distribution being defined on a set of operators of a local nᵤₘ-qudit polytope specified by an update map number nᵤₘ of qudits which is smaller than an input number nᵢₙ of qudits specifying an input polytope of the update map. To be more precise, computing the update rule for an operator in

$${Λ}_{n}^{l}$$

under a single-qudit Pauli measurement may be performed by decomposing an associated operator that lives in

$${Λ}_{n - 1}^{l} ,$$

which is more efficient since the latter polytope is of smaller dimension. More details are presented below, in particular in Sec. 7.2.

The update map probability distribution for the j-th update map associated with the j-th Pauli measurement, which, for qubits, may be described by the projector

$${Π}_{a}^{s} = ( + {( - 1 )}^{s} {T}_{a} ) / 2$$

may be obtained in the following way in one example: Compute for each input operator A_{α} the action of the projective measurement according to

$${Π}_{α}^{s} {A}_{α} {Π}_{α}^{s} = {\sum }_{β ∈ {O}_{out}} {q}_{α} ( β , s ) {\tilde{A}}_{β} ,$$

wherein Oₒᵤₜ={Ā_{β}}_{β} is the set of output operators of the output polytope. The coefficients q_{α}(β,s)>0 then define the output probability distribution. I.e., the action of the j-th Pauli measurement is simulated by sampling over the probability distribution {q_{α}(β,s)}_{β} defined over the operators Ā_{β} of the output set.

In yet another embodiment of the method according to the first aspect of the present invention, at least one Pauli measurement may be a non-destructive measurement and the output polytope of the corresponding update map may correspond to the input polytope of the update map. In one example, the update map may map an operator of an input set of operators to an operator of an output set of operators, and the input set may be identical to the output set.

In another embodiment of the method according to the first aspect of the present invention at least one Pauli measurement may be a destructive single-qudit measurement and the output number nₒᵤₜ specifying the output polytope of the corresponding update map may be one less than the input number nᵢₙ specifying the input polytope of the corresponding update map.

According to a further embodiment of the method according to the first aspect of the present invention, the probability distribution may be defined by weights of a representation of the resource state by a weighted sum of the operators of the initial set of operators. I.e., when the initial set of operators is of the form {A_{α}}_{α ∈O}_{_{I}} for some operators A_{α} in the local n-qudit polytope

$${Λ}_{n}^{l} ,$$

and some index set O_{I} may comprise representing the initial resource state|Ψᵣ [symbol] by |Ψᵣ [symbol] Ψᵣ|=Σ_{α∈O}_{_{I}}p(α)A_{α}, wherein the positive coefficients p(α) sum up to 1, Σ_{α∈O}_{_{I}}p(α)=1 and thereby define the probability distribution associated with the resource state.

In one example, the decomposition may be obtained by solving an optimization problem. In particular, the optimization problem may be solved by a linear program. In particular, the linear program may be the phase 1 of the simplex method given by

$${min}_{p , u , v} \{ {\sum }_{a ∈ {E}_{n}} {u}_{a} + {v}_{a} : ρ = {\sum }_{a ∈ {E}_{n}} ( {u}_{a} - {v}_{a} ) {T}_{a} + {\sum }_{α ∈ {O}_{I}} p ( α ) {A}_{α} , {u}_{a} , {v}_{a} \geq 0 ∀ a ∈ {E}_{n} , p ( α ) \geq 0 ∀ a ∈ {O}_{I} \}$$

Here, for qubits,

$${E}_{n} = {ℤ}_{2}^{n} \times {ℤ}_{2}^{n}$$

and the Pauli operators Tₐ=i^{a}^{_{X}}^{·a}^{_{Z}}X^{(a}^{_{X}}⁾^{₁}Z^{(a}^{_{Z}}⁾^{₁}⊗ . . . ⊗x^{(a}^{_{X}}⁾^{ₙ}Z^{(a}^{_{Z}}⁾^{ₙ}; were introduced above.

When the initial set of operators comprises all vertices of the local n-qudit polytope, it may be possible to decompose the initial resource state so that all coefficients p(α) are positive or zero, i.e., p(α) ≥0, and thereby a probability distribution may be defined. However, then the initial set of operators does not contain all vertices of the local n-qudit polytope, which is generally the case, as not all vertices are known for any number of qudits, the linear program may be infeasible. I.e., one may only obtain solutions where at least one coefficient p(α) is not positive. In this case, one may still obtain a valid probability distribution as it is explained in more detail below.

One embodiment of the method according to the first aspect of the present invention may comprise the generation of the computational key. As the structure of the local n-qudit polytope is much simpler than the structure of the Λ-polytope disclosed in US 2023/0206102 A1, the computational key of the present invention may be generated much more efficiently than in the cited prior art.

In one expedient embodiment, the generation of the computational key may be by a key generation computer which comprises a classical processor or a quantum processor. In one example, the key generation computer may comprise the classical processor and the quantum processor. However, the invention is not limited to this, and the processor of the key generation computer may be a classical processor in one example. In another example, the processor of the key generation computer may be a quantum processor. The key generation computer may be provided at a location which is remote from the classical computer on which the simulation is implemented. However, the invention is not limited to this. In one example, the classical processor or quantum processor may be programmed to solve the optimization problem presented above. In one example, the quantum processor may be a processor of an adiabatic quantum computer, and the adiabatic quantum computer may be programmed to solve the optimization problem.

The generated computational key may be stored on a storage medium in one example. The storage medium may be a non-transitory storage medium. In one example, the computation key may be stored in a data base. While the generation of the computational key for a given resource state may be time consuming, the computational key needs to be generated only once for each resource state of interest and may then be stored on the storage medium. Then, when a formulation of a computational problem includes the resource state, the computational key may be retrieved from the storage medium. The key generation computer may be considered as a factory for producing computational keys.

In a further expedient embodiment, the resource state may have a classical description in terms of a structure parameter and wherein the generation of the computational key may be on the basis of the structure parameter. In this case, only the structure parameter may be provided to the key generation computer. The structure parameter may comprise classical data in one example.

In particular, when the resource state is the magic Cluster state defined above, the structure parameter may comprise the state parameter specifying the graph G and the subset U_{V} of vertices. Thus, compared to the method disclosed in US 2023/0206102 A1, the structure parameter used for the generation of the computational key does not only include the number n of qudits but also includes the graph G and the subset U_{V} of vertices.

According to a second aspect of the present invention, there is provided a method for generating a computational key by a key generation computer, the computational key being configured for simulating a measurement-based quantum computation comprising an application of a sequence of J≥1 steps of Pauli measurements to an entangled resource state of a plurality of n qudits on a classical computer, the qudits being quantum mechanical d-level systems, d≥2, the method comprising:
representing the resource state by a weighted sum of an initial set of operators of an initial polytope of trace-one Hermitian operators on a Hilbert space associated with the plurality of qudits;
defining a probability distribution over the initial set of operators by the weights of the representation:
generating the computational key on the basis of the probability distribution such that it is indicative of at least one initial sample from the probability distribution,
wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

The resource state may be represented by the weighted sum of the initial set of operators by solving the optimization problem introduced above. The weights p(α) introduced above may define the probability distribution.

The computational key may comprise a representation of the at least one sample over the probability distribution in one example. In another example, the computational key may comprise instructions to generate the at least one sample. For example, the computational key may comprise the probability distribution in one example. Within this specification, the computational key may also be denoted as “classical key”.

The key generation computer may comprise a classical processor or a quantum processor in one example. In one example, the key generation computer may comprise the classical processor and the quantum processor. However, the invention is not limited to this, and the processor of the key generation computer may be a classical processor in one example. In another example, the processor of the key generation computer may be a quantum processor.

According to a third aspect of the present invention, there is provided a computing system for simulating a measurement-based quantum computation comprising an application of a sequence of J≥1 steps of Pauli measurements to an entangled resource state of a plurality of n qudits, the qudits being quantum mechanical d-level systems, d≥2, the system comprising a classical computer and a key generation computer, wherein
the key generation computer is configured to generate a computational key that is indicative of at least one initial sample from a probability distribution that is associated with the resource state and is defined on an initial set of operators of an initial polytope of trace-one Hermitian operators on a Hilbert space associated with the plurality of qudits, and to provide the computational key to the classical computer,
the classical computer is configured to receive the computational key and to simulate the measurement-based quantum computation by use of the computational key,
wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

The computing system according to the third aspect of the present invention is configured to implement the method according to the first aspect of the present invention.

In one example, the classical computer may be configured to receive a classical description of the sequence of the J measurement steps of the measurement-based quantum computation, and/or the associated sequence of the J update maps.

In one example, the key generation computer may comprise a classical processor or a quantum processor. In one example, the key generation computer may comprise the classical processor and the quantum processor. However, the invention is not limited to this, and the processor of the key generation computer may be a classical processor in one example. In another example, the processor of the key generation computer may be a quantum processor

In one further example, the computing system according to the third aspect of the present invention may be configured to communicate with at least one client computer. In particular, the at least one client computer may be in communication with the classical computer. In one example, the classical computer may comprise a plurality of classical computers, and each client computer of a plurality of client computers may be in communication with one of the classical computers. The client computer may be configured to receive a computational problem. The computational problem may be a measurement-based quantum computation in one example. If the computational problem is not a measurement-based quantum computation, the client computer may be configured to map the computational problem to a measurement-based quantum computation where a sequence of J measurement steps is applied to a resource state. The measurement-based quantum computation may be classically described by a structure parameter representing the resource state and a classical description of the sequence of the J measurement steps. The client computer is configured to transmit the description of the computational problem to the classical computer. The classical computer may be configured to communicate the structure parameter to the key generation computer. The key generation computer may generate the computational key on the basis of the structure parameter and provide the computational key to the classical computer. The classical computer may simulate the measurement-based quantum computation on the basis of the computational key and communicate the result of the simulation to the client computer. The communication between any of the systems and computers mentioned within this specification may be by way of a communication network, such as a Local Area Network (LAN), Wide Area Network (WAN), or the Internet, wired or wireless data links, optical data links, electromagnetic signals, or other data communication channel(s) in one example.

The key generation computer and the classical computer may be understood as a server in one example. The simulation may be fully implemented on the server in this example. The at least one client computer never obtains the computational key. The key generation computer may comprise a storage medium, in particular a non-transitory storage medium, configured to store the generated key. Then, the computational key only needs to be generated once for each structure parameter which saves computational resources.

According to a fourth aspect of the present invention, there is provided a computer program product for simulating a measurement-based quantum computation on a classical computer, wherein the computer program product includes instructions, which, when the program is carried out by a classical computer, cause the classical computer to:
receive a classical description of the measurement-based quantum computation, the classical description comprising a classical description of an entangled resource state of a plurality of n qudits, the qudits being quantum mechanical d-level systems, d≥2;
simulate the measurement-based quantum computation, wherein the simulation comprises use of a computational key that is indicative of at least one initial sample from a probability distribution that is associated with the resource state and is defined on an initial set of operators of an initial polytope of trace-one Hermitian operators on a Hilbert space associated with the plurality of qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer stales are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

The computer program product according to the fourth aspect of the present invention may be used for implementing the method according to the first aspect of the present invention.

The classical description of the resource state may comprise the structure parameter in one example.

In one example, the classical description of the measurement-based quantum computation may further comprise a classical description of a sequence of J≥1 steps of Pauli measurements to be applied to the resource state.

In another example, the computer program product may include instructions, which, when the program is carried out by a classical computer, cause the classical computer to receive the computational key, e.g., from the key generation computer or from a storage medium. However, the invention is not limited to this.

According to a fifth aspect of the present invention, there is provided a computer-readable storage medium comprising instructions which, when executed by a classical computer, cause the classical computer to:
receive a classical description of a measurement-based quantum computation, the classical description comprising a classical description of an entangled resource state of a plurality of n qudits, the qudits being quantum mechanical d-level systems, d≥2:
simulate the measurement-based quantum computation, wherein the simulation comprises use of a computational key that is indicative of at least one initial sample from a probability distribution that is associated with the resource state and is defined on an initial set of operators of an initial polytope of trace-one Hermitian operators on a Hilbert space associated with the plurality of qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

The computer-readable storage medium may be a non-transitory storage medium in one embodiment. The computer-readable storage medium according to the invention may be in any of a wide variety of forms. The computer-readable storage medium may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In one example, the classical description of the measurement-based quantum computation may further comprise a classical description of a sequence of J≥1 steps of Pauli measurements to be applied to the resource state.

According to a sixth aspect of the present invention, there is provided a computer program product for generating a computational key which is configured for simulating a measurement-based quantum computation on a classical computer, wherein the computer program includes instructions which, when the program is carried out by a key generation computer, cause the key generation computer to:
receive a classical description of an n-qudit resource state of a measurement-based quantum computation, the qudits being quantum mechanical d-level systems, d≥2;
represent the resource state by a weighted sum of an initial set of operators of an initial polytope of trace-one Hermitian operators on a Hilbert space associated with the n qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors;
define a probability distribution over the initial set of operators by the weights of the representation;
generate the computational key on the basis of the probability distribution such that it is indicative of at least one initial sample from the probability distribution.

The computer program product according to the fifth aspect of the present invention may be used to implement the method according to the second aspect of the present invention.

The key generation computer may comprise a classical processor and/or a quantum processor, and the computer program may be carried out by the classical processor and/or the quantum processor.

According to a seventh aspect of the present invention, there is provided a computer-readable storage medium comprising instructions which, when executed by a key generation computer, cause the key generation computer to:
receive a classical description of an n-qudit resource state of a measurement-based quantum computation, the qudits being quantum mechanical d-level systems, d≥2;
represent the resource state by a weighted sum of an initial set of operators of an initial polytope of trace-one Hermitian operators on a Hilbert space associated with the n qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors;
define a probability distribution over the initial set of operators by the weights of the representation;
generate the computational key on the basis of the probability distribution such that it is indicative of at least one initial sample from the probability distribution.

The computer-readable storage medium may be a non-transitory storage medium in one embodiment. The computer-readable storage medium according to the invention may be in any of a wide variety of forms. The computer-readable storage medium may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

The key generation computer may comprise a classical processor and/or a quantum processor.

In the following, the invention will be described in greater detail by way of example with reference to the drawings in which

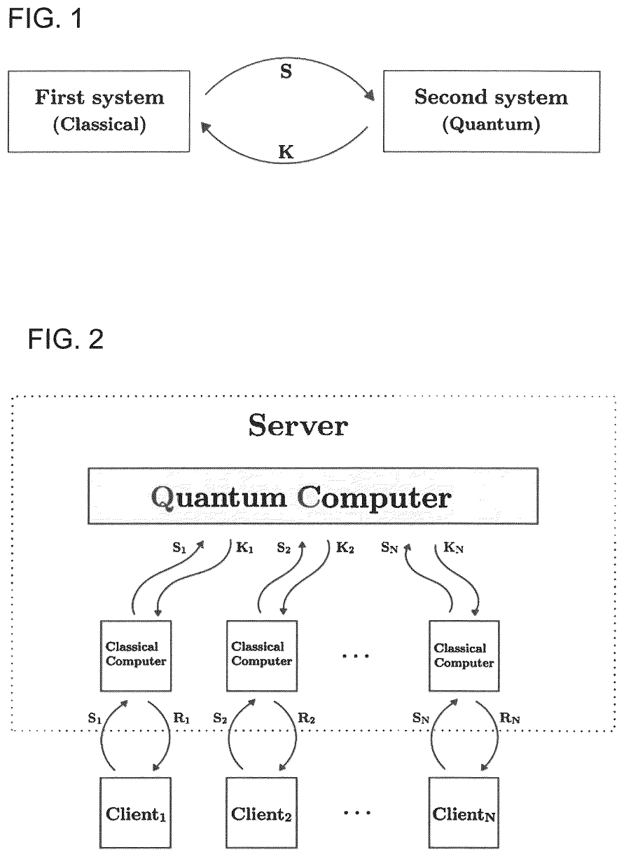

FIG. 1: The first system communicates a structure parameter S consisting of a bit representation of the pair (G; U), and the second system communicates back a universal classical key K=K(G; U). Once the computational key is generated it can be stored. This key can be shared with another system (behaving like the first system) which aims to solve a computational problem whose structure parameter is the same as that of the first system;

FIG. 2: The server consists of a quantum computer (second system) and a collection of classical computers (each behaves like the first system). Each client who runs a classical computing device can pass a structure parameter Sᵢ, a classical encoding of their quantum circuit, to one of the classical components of the server. This classical component passes the structure parameter to the quantum computer inside the server. The quantum computer returns a universal key Kᵢ and shares it with the classical part, which is used for classical simulation. The result of the simulation Rᵢ is then passed to the client;

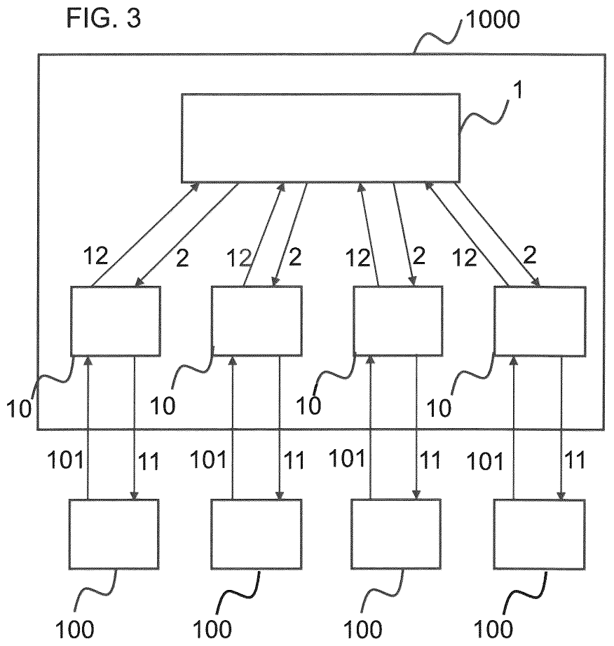

FIG. 3 is a schematic representation of an embodiment of the computing system according to the third aspect of the present invention configured to implement the method according to the first aspect of the present invention.

FIG. 3 is a schematic representation of a computing system 1000 for simulating a measurement-based quantum computation according to the method of the first aspect of the present invention. The computing system 1000 comprises a key generation computer 1 which may comprise a quantum processor and/or a classical processor and one or more classical computers 10. The key generation computer 1 and the classical computer(s) 10 are configured to communicate with each other as indicated by the arrows 2, 12. The communication may be by way of a communication network, such as a Local Area Network (LAN), Wide Area Network (WAN), or the Internet, wired or wireless data links, optical data links, electromagnetic signals, or other data communication channel(s) in one example. The classical computer 10 and the key generation computer 1 may be located at the same location or at different locations.

The computing system 1000 is configured to communicate with a plurality of client computers 100. The client computers 100 may be located at different locations. Each client computer 100 has one of the classical computers 10 associated therewith. However, the invention is not limited to this, and there may be more than one client computer 100 associated with one, more than one or each of the classical computers 10. The client computers 100 and the classical computers 10 are configured to communicate with each other as indicated by the arrows 11, 101. The communication may be by way of a communication network, such as a Local Area Network (LAN), Wide Area Network (WAN), or the Internet, wired or wireless data links, optical data links, electromagnetic signals, or other data communication channel(s) in one example.

In one embodiment, a user may provide a computational problem to one of the client computers 100. In one example, the computational problem may be formulated in the measurement-based Pauli model (MBPC). For example, the client computer 100 may be configured to receive a structure parameter specifying a dimension d of a qudit system and a state parameter. The state parameter may comprise a graph described by a vertex set V={1, 2, . . . , n} of n vertices corresponding to the n qudits and a set E of edges eᵢⱼ, and a subset U_{V} of the vertex set. The state parameter may be representative of a magic Cluster state |ψ_{G,U}_{_{V}} [symbol] =E(G)T^{⊗U}^{_{V}}|+ [symbol] ^{⊗n}. On which is a resource state of the measurement-based quantum computation and which has been introduced above. In one expedient example, the entangling operation E(G) may be of the form E(G)=⊗_{i,j;e}_{ᵢⱼ}_{∈E} Eᵢⱼ, wherein Eᵢⱼ is a controlled-Z gate between the qudit i and the qudit j.

Furthermore, the client computer 100 may be configured to receive a classical description of J steps of Pauli measurements of the measurement-based quantum computation. In the MBPC model, a sequence of J steps of single-qudit Pauli measurements is applied to the initial resource state. For example, the classical description may specify the qudit to be measured and the Pauli operator to be measured. The single-qudit measurements may be adaptive measurements in one example. Additionally, or alternatively, the single-qudit measurements may be destructive measurements in another example.

In another embodiment, the client computer 100 may be configured to receive a description of the computational problem which is different from the measurement-based quantum computation. For example, the computational problem may be a quantum algorithm formulated in the quantum circuit model. The client computer 100 may be configured to map the computational problem to the measurement-based Pauli model. Alternatively, the client computer may pass the quantum circuit to the classical computer 10, which may translate it to the MBPC model. The measurement-based Pauli model is a universal model for quantum computation, so any computational problem may be mapped to the measurement-based Pauli model.

The client computer 100 communicates the structure parameter to the associated classical computer 10. The classical computer 10 communicates the structure parameter to the key generation computer 1. The key generation computer 1 generates the computational key on the basis of the structure parameter. The computational key is indicative of at least one sample from a probability distribution that is associated with the resource state.

To this end, the key generation computer 1 may be programmed to solve the optimization problem

$${min}_{p , u , v} \{ {\sum }_{a ∈ {E}_{n}} {u}_{a} + {v}_{a} : ρ = {\sum }_{a ∈ {E}_{n}} ( {u}_{a} - {v}_{a} ) {T}_{a} + {\sum }_{α ∈ {V}_{I}} p ( α ) {A}_{α} , {u}_{a} , {v}_{a} \geq 0 ∀ a ∈ {E}_{n} , p ( α ) \geq 0 ∀ a ∈ {V}_{I} \}$$

wherein V_{I} is a set of labels of operators of an initial operator set. The initial operator set is a set of operators of the local n-qudit polytope defined above. In particular, the initial operator set may comprise vertices of the local n-qudit polytope. For example, the initial operator set may comprise at least one vertex which is a locally closed vertex introduced above. In one expedient embodiment, the initial operator set may comprise at least one vertex which is of the form A_{(\vec{a},\vec{b},\vec{c})}=Aₐ_{₁}_{b}_{₁}_{c}_{₁}⊗Aₐ_{₂}_{b}_{₂}_{c}_{₂}⊗ . . . ⊗Aₐ_{ₙ}_{b}_{ₙ}_{c}_{ₙ} wherein Aₐ_{ᵢ}_{b}_{ᵢ}_{c}_{ᵢ} is a vertex of the local single-qudit polytope. In the case of qubits, the vertices of the single-qubit polytope are of the form

$${A}_{abc} = \frac{1}{2} ( 𝟙 + {( - 1 )}^{a} X + {( - 1 )}^{b} Y + {( - 1 )}^{c} Z ) ,$$

wherein a,b,c∈{0,1}. Additionally, or alternatively, the initial operator set may comprise at least one vertex which is a max-weight type introduced above.

Once the probability distribution {p(α)}_{α} is determined, the computational key may be generated. In one example, the computational key may comprise a plurality of K≥1 samples {A_{α}}_{α∈V}_{_{I}} of the operators of the initial operator set sampled according to the probability distribution.

The key generation computer 1 may provide the computational key to the classical computer 10. The classical computer 10 may simulate the measurement-based quantum computation by an application of a sequence of update maps to each sample of the computational key. In particular, the update maps may be applied to a classical representation of the sample. For example, each sample A_{α} may be classically represented by the corresponding index α∈V_{I}.

Each update map corresponds to the respective single-qudit Pauli measurement of the J Pauli measurements. I.e., the first update map of the sequence receives the sample as an input and outputs an operator of an output polytope, wherein the output polytope is either the local n-qudit polytope (when the single-qudit Pauli measurement associated with the first update map is non-destructive) or a local (n−1)-qudit polytope (when the single-qudit Pauli measurement associated with the first update map is destructive).

The output operator may be determined by sampling, for each update map, over an associated update map probability distribution. The update map probability distribution may be determined in advance. When the j-th (qubit) Pauli measurement is described by the projectors

$${\prod }_{a}^{s} = ( 𝟙 + {( - 1 )}^{s} {T}_{a} ) / 2 ,$$

one may compute for each possible input operator A_{α} the action of the projective measurement according to

$${\prod }_{α}^{s} {A}_{α} {\prod }_{a}^{s} = {\sum }_{β ∈ {O}_{out}} {q}_{α} ( β , s ) {\tilde{A}}_{β} ,$$

wherein Oₒᵤₜ={Ã_{β}}_{β} is the set of output operators of the output polytope. The coefficients q_{α}(β,s)>0 then define the output probability distribution. I.e., the action of the j-th Pauli measurement is simulated by sampling over the probability distribution {q_{α}(β,s)}_{β} defined over the operators Ã_{β} of the output set. I.e., in the simulation, only a single operator is propagated by applying the sequence of update maps. Thereby, the simulation may be implemented efficiently on the classical computer.

### 1 Introduction

Our invention is a new classical simulation algorithm for universal quantum computation. It is known in the current literature that quantum computation can be represented by a quasi-probability distribution, a probability distribution that also admits negative values; see [1]. The negative values render the classical algorithm exponentially hard. On the other hand, a more recent simulation method, known as the Λ simulation [2], represents any quantum computation positively. This method is based on generating a universal classical key by using an operator-theoretic polytope, the so-called Λ polytope; see the patent application U.S. Ser. No. 17/995,068. Our method is also based on generating a universal classical key by using an operator-theoretic polytope. However, our invention is distinguished in two fundamental ways:
1. Our computational model is measurement-based quantum computation (MBQC) based on single-qubit Pauli measurements. Earlier sampling methods are based on the computational model known as quantum computation with magic states (QCM). Our method includes QCM as a particular type of MBQC.
2. Our classical key generation is based on a novel method that is more efficient than the known algorithms. The MBQC model gives a new key generation method that is simpler than the previous methods based on QCM. Our operator-theoretic polytope can be identified as the non-signaling polytope of a multi-partite Bell scenario.

The novel application of our classical simulation algorithm is the distribution of the power of quantum computers to classical computers. The method consists of two systems:
First system: a classical computer.
Second system: a quantum computer (or a powerful classical supercomputer).

The first system wants to solve a problem using a quantum algorithm (or a powerful classical supercomputer). The first system converts the quantum algorithm into an implementation in the MBQC model. The first system communicates this decomposition to the second system as classical information. The computational problem has a structure parameter consisting of the number n of qubits and an initial state parameter given by a pair (G,U). In the pair, G is a graph with vertex set {1, 2, . . . , n}, and U is a subset of the vertices. The graph specifies the amount of entanglement that needs to be present in the initial quantum state. In standard MBQC, the initial state is taken to be a cluster state, a particular type of graph state. The subset of vertices specifies which qubits must be pre-pared in the magic state. This model implements the quantum algorithm using a sequence of single-qubit Pauli measurements. The measurement sequence is adaptive in that the choice of the measurement at a time step of the quantum algorithm depends on the outcomes of the previous measurements. The first system passes a bit representation of (G,U) to the second system. The second system computes a classical key K(G,U) and shares it with the first system. The first system can simulate any quantum computation initiated at the “magic cluster state” determined by (G,U). Once the second system obtains the classical key, it can simulate such quantum computations classically.

FIG. 1: The first system communicates a structure parameter S consisting of a bit representation of the pair (G,U), and the second system communicates back a universal classical key K=K(G,U). Once the computational key is generated it can be stored. This key can be shared with another system (behaving like the first system) which aims to solve a computational problem whose structure parameter is the same as that of the first system.

In the envisioned application of this technology, quantum computers serve as factories for universal classical key generators. These keys only depend on the entanglement structure of the initial state and the amount of magic states. The technology will be implemented through an interaction between a server and multiple clients. The server comprises a quantum computer, acting as the second system, and a collection of classical units, acting as the first system. Clients interact with the classical units to submit their requests for the simulation of quantum circuits of interest.

### 2 Summary of the Invention

Our method involves the following steps:
1. The first system has the description of a quantum computation in the form of classical data specifying which quantum gates and measurements to be applied to which input states. The algorithm may be designed for a computational problem, e.g., Shor's factoring or Grover's search algorithms.
2. The quantum circuit is first converted to a computation in the MBQC model based on single-qubit Pauli measurements. In this model, the initial state is a magic cluster state, prepared by entangling a product state where some of the qubits are prepared in the magic states. The entanglement pattern is specified by a graph G, and the magic states are specified by a subset U of the vertices. Then, the computation proceeds in a sequence of adaptive single-qubit Pauli measurements. The initial state is a mixture of cluster states, which are standard in the original formulation of MBQC, and magic states used in the QOM model. For quantum computational power, both features must be present in the initial state. A cluster state (without magic) or a magic state (without entanglement) can be efficiently classically simulated.
3. A classical representation of (G,U) is passed to the second system. The second system uses a polytope-theoretic method to produce a probability distribution. The distribution is on a polytope's finite set of vertices, and is obtained by solving a linear optimization problem. This step is similar to the Λ simulation method. However, the main novelty of our method is that the polytope used in our invention is much simpler and, hence, can be generated more efficiently. Our polytope is a non-signaling polytope of a multi-partite Bell scenario. The second system may use software such as CPLEX, Gurobi, and GLPK for solving the linear optimization problem or the quantum implementations of the underlying classical algorithms, possibly on an adiabatic quantum computer.
4. The classical key generated by the second system is a sample or samples from the probability distribution. The distribution is defined on the set of vertices of a polytope, which we call the local Λ polytope. If the computation is deterministic, then a single sample suffices. Otherwise, the accuracy of the simulation depends on the number of samples used.
5. The first system obtains the classical key and the rest of the computation proceeds with classical post-processing on the key.

The implementation of our invention involves an interaction between a server and multiple clients, as depicted in FIG. 2). The server consists of two components: (1) a set of classical computers functioning as the first system and (2) a quantum computer functioning as the second system. The classical components of the server accept a structure parameter Sᵢ, which they can pass to the second system. The second system then returns a computational key Kᵢ to one of the classical computers. This key allows the classical computers to run the simulation algorithm and output the result Rᵢ of the computation. Each client interacts with the server by sharing a structure parameter Sᵢ with the classical component of the server. Once the server completes the classical simulation, the result Rᵢ is shared with the client. This implementation integrates the first and second systems into the server, ensuring that the classical keys are not distributed to the clients. Therefore at no point in this process does the clients obtain the keys. Instead, clients access quantum computational power through their connection to the server. The server classically simulates the quantum algorithm using universal keys generated by the quantum computer. The quantum computer's sole task is to generate these keys, which are stored in a database as classical information and used when a computation's structure parameter requires the corresponding classical key for simulation.

An important distinction exists between the classical key used in the Λ simulation and our method. The classical key only depends on the structure parameter n in the former. In our case, the key essentially depends on the graph specifying the entanglement pattern and a vertex subset identifying the location of the magic states. So, the possible keys for a given structure parameter are given by the possible graphs on the vertex {1, 2, . . . n} and subsets U. The main reason for this difference is that we only use single-qubit (local) Pauli measurements in our computational model of choice. On the other hand, Λ simulation uses non-local Pauli measurements as well. In addition, our keys have a tensor structure; that is, if A_{α} and A_{β} are vertices representing keys for size parameters n and m, then A_{α}⊗A_{β} is a vertex representing a key for size parameter n+m.

Our simulation method is expected to improve the efficiency of generating the universal classical key. This improvement stems from differences in the polytope structures used in our

FIG. 2: The server consists of a quantum computer (second system) and a collection of classical computers (each behaves like the first system). Each client who runs a classical computing device can pass a structure parameter Sᵢ, a classical encoding of their quantum circuit, to one of the classical components of the server. This classical component passes the structure parameter to the quantum computer inside the server. The quantum computer returns a universal key Kᵢ and shares it with the classical part, which is used for classical simulation. The result of the simulation Rᵢ is then passed to the client calculations. Although both Λ and the local Λ polytopes have the same dimension, the local Λ polytope encompasses a proper subset of the inequalities found in Λ. This reduces the input size for the double description (DD) method, as the local version involves fewer inequalities. The number of inequalities in each case is directly related to the number of stabilizer states and their local variants. Specifically, the number of inequalities for Λ and local Λ are 2ⁿ×2^{(0.5+o(1))n}^{²}⁾ [3] and 2ⁿ×3ⁿ, respectively. Moreover, our computational model benefits from simpler update rules by solely utilizing single-qubit measurements, in contrast to the more complex rules required when non-local measurements are involved. In addition, our model employs destructive measurements, unlike previous QCM-based models that use non-destructive measurements. These simplifications further contribute to the overall efficiency of our method.

### 3 the Computational Model

We begin by reviewing basic components of quantum circuits. See [4] for details.

A qubit is a quantum system with Hilbert space [symbol] ². The classical bit [symbol] ₂={0, 1} is represented using the computational basis vectors

$$\vert 0 〉 = ( \begin{matrix}1 \\ 0\end{matrix} ) and \vert 1 〉 = ( \begin{matrix}0 \\ 1\end{matrix} ) .$$

A quantum circuit consists of the following components:
An initial quantum state, a unit vector in ( [symbol] ²)^{⊗n}. Typically this state is chosen to be the computational basis vector

$$\vert 0 … 0 〉 = ( \begin{matrix}1 \\ 0\end{matrix} ) ⊗ … ⊗ ( \begin{matrix}1 \\ 0\end{matrix} ) .$$

The algorithm is implemented by a sequence of unitary operators. It is well-known that the Hadamard gate

$$H = \frac{1}{\sqrt{2}} ( \begin{matrix}1 & 1 \\ 1 & - 1\end{matrix} ) ,$$

the T-gate

$$( \begin{matrix}1 & 0 \\ 0 & {e}^{i π / 4}\end{matrix} ) ,$$

and the controlled-Z gate

$${E}_{12} = ( \begin{matrix}1 & 0 & 0 & 0 \\ 0 & 1 & 0 & 0 \\ 0 & 0 & 1 & 0 \\ 0 & 0 & 0 & - 1\end{matrix} )$$

constitute a universal set. They are represented by the following circuit elements, respectively:
The computation ends with quantum measurements which are usually in the computational basis

$$\{ \vert 0 〉 = ( \begin{matrix}1 \\ 0\end{matrix} ) , \vert 1 〉 = ( \begin{matrix}0 \\ 1\end{matrix} ) \} .$$

The circuit component for a measurement is denoted by
where A is one of the Pauli operators

$$X = ( \begin{matrix}0 & 1 \\ 1 & 0\end{matrix} ) Y = ( \begin{matrix}0 & - i \\ i & 0\end{matrix} ) Z = ( \begin{matrix}1 & 0 \\ 0 & - 1\end{matrix} ) . \qquad ( 1 )$$

The output of the circuit is s∈ [symbol] ₂.
An n-qubit Pauli operator is of the form

$$A = {A}_{1} ⊗ {A}_{2} ⊗ … ⊗ {A}_{n}$$

where each Aᵢ is a 2×2 Pauli matrix, i.e., the identity matrix [symbol] or one of X, Y, Z defined in Eq. (1). Pauli operators generate a subgroup, denoted by Pₙ, in the unitary group U(( [symbol] ²)^{⊗n}) called the Pauli group. The normalizer of Pa inside the unitary group (modulo scalars) is called the Clifford group.

Our computational model is a mixture of the magic state and the measurement-based models.

1. The quantum computation with magic state model (QCM) [5]:
initiates at a magic state, which can be taken as |T [symbol] ^{⊗n} where

$$\vert T 〉 = T \vert + 〉 = \frac{1}{\sqrt{2}} ( \vert 0 〉 + {e}^{i π / 4} \vert 1 〉 ) ,$$

and
proceeds with a sequence of adaptive Pauli measurements not necessarily local, i.e., they can contain multi-qubit measurements.
The sequence of measurements can be chosen to be compatible, i.e., consisting of commuting Pauli operators, without losing universality. This variant is called the Pauli-based computation (PBC) [6, 7]. This computational model can be generalized to qudits of arbitrary local dimensions. It is known that the resulting model is universal for odd-prime dimensions [8].

2. The measurement-based quantum computation (MBQC) model [9]:
initiates at an entangled state, usually it is a cluster state

$${\vert {ψ}_{G} 〉 = E ( G ) \vert + 〉}^{{⊗}_{n}} .$$

where E(G)=⊗ₑ_{ᵢⱼ}_{∈E} Eᵢⱼ, and
proceeds with a sequence of adaptive local measurements, typically in the X-Y plane of the Bloch sphere.
MBQC can also be generalized to qudits; see [10].

### 3.1 Measurement-Based Pauli Model

We adapt a computational model that uses features from each of these computational models. A computation in the measurement-based Pauli model (MBPC)
initiates at a magic cluster state, we will be taking the following one

$${\vert {ψ}_{G , U} 〉 = E ( G ) {T}^{{⊗}_{U}} \vert + 〉}^{{⊗}_{n}}$$

where U⊆V is a vertex subset, and
proceeds with a sequence of adaptive single-qubit Pauli X and Y measurements.

The initial state |ψ_{G,U} [symbol] is obtained by first preparing all the qubits in the +1-eigenstate of X and then applying the T gate to a subset of these qubits. Then the entangling gate E(G) is applied to the product state. A quantum algorithm in this model is specified by an initial state |ψ_{G,U} [symbol] and a sequence of adaptive single-qubit Pauli measurements. This model of computation is introduced in [11], see also [12].

The universality of the model follows from the implementation of the H and T gates. The measurement patterns specifying the adaptive sequences of measurements are obtained using the theory of measurement calculus [13]:

MBPC can be seen as a version of PBC where measurements are local and destructive. The MBPC model can be generalized to qudits by combining ideas in [8] and [10].

Example 3.1. Following the treatment in of Anders and Browne [15], an MBQC with classical linear side processing and access to a certain tripartite quantum state can be used to deterministically compute the nonlinear Boolean OR function. Without access to a quantum resource only linear Boolean functions can be computed, thus access to such a resource boosts the computational power.

The state used in is the well-known Greenberger-Horne-Zeilinger (GHZ) state |GHZ [symbol] =(|000)+|111 [symbol] )/\sqrt{2}. Measurements of local Pauli operators
{X₁, X₂, X₃}, {X₁, Y₂, Y₃}, {Y₁, X₂, Y₃}, {Y₁, Y₂, X₃}
   produce outcomes that are individually random. However, since |GHZ [symbol] is an eigenstate of the Pauli operators XXX, −XYY, −YXY, and −YYX the product of the outcomes are deterministic. By inspection of the generators, we see that the GHZ state is not a graph state resulting from E(G)|+ [symbol] ^{⊗3}, but it is equivalent to one up to local Clifford unitaries.

Consider instead the graph state |ψ_{G} [symbol] =E(G)|+ [symbol] ^{⊗3}=(|+0+ [symbol] +|−1− [symbol] )/\sqrt{2} which is an eigenstate of operators −YXY, YYZ, ZXZ, and ZYY. It is straightforward to observe that the measurement sequences
{X₁, X₂, Y₃}, {Y₁, Y₂, Z₃}, {Z₁, X₂, Z₃}, {Z₁, Y₂, Y₃}
   deterministically compute the nonlinear Boolean NOR function, which is related to OR by a constant factor. Since in both cases the computed gates together with the NOT gate are classically universal, both models have equivalent computational power. Note that from a classical simulation perspective all that matters is the measurement statistics.

### 4 the Classical Simulation Algorithm

In this section we introduce a general framework for quantum computation based on adaptive sequence of quantum operations that includes our main computational model described in Section 3. Then we introduce a classical simulation algorithm for this general computational framework.

### 4.1 Adaptive Quantum Operations

Our classical simulation algorithm takes as input a quantum computation described in the MBPC model (Section 3). In this model an algorithm is implemented by a sequence of adaptive measurements. To be able to capture adaptivity cleanly we will rely on the more general notion of an instrument [16]. We will use the following basic definitions:
For a Hilbert space [symbol] we will write L( [symbol] ) for the space of linear operators.
A linear map Φ: L( [symbol] )→L( [symbol] ) is positive if Φ(A) is positive for every positive operator A.
A linear map Φ is completely positive if Φ⊗ [symbol] is positive for every Hilbert space [symbol] . We will write CP( [symbol] , K) for the space of completely positive maps.
A trace preserving completely positive map is called a quantum channel.
An instrument with outcome set E is a function Φ: Σ→CP( [symbol] , [symbol] ) such that Σ_{s∈Σ}^{Φ}^{^{s}} is a quantum channel.

Any quantum measurement described by projectors {Π^{s}: s∈Σ} specifies an instrument Φ: Σ→CP( [symbol] ) where Φ^{s}(A)=Π^{s}AΠ^{s}.

To capture the idea of adaptive measurements we will need parametrized instruments. A parametrized instrument is a function

$$Γ \times \sum \to CP ( ℋ , 𝒦 )$$

that sends a pair (a,s), where a∈Γ is the parameter and s∈Σ is the output, to a completely positive map

$${Φ}_{a}^{s} : L ( ℋ ) \to L ( 𝒦 )$$

such that

$${\sum }_{s ∈ \sum } {Φ}_{a}^{s}$$

is quantum channel for every parameter a. The role of the parameter is to reflect possible choices at a given step that may depend on earlier outcomes. For example, given another parametrized instrument Ψ:Σ×Θ→CP( [symbol] , [symbol] ), where this time the parameter is the output set of the previous instrument, we can compose to obtain a new parametrized instrument

$$Ψ ∘ Φ : Γ \times Θ \to CP ( ℋ , ℒ )$$

defined by

$${( Θ ∘ Φ )}_{a}^{r} = {\sum }_{s ∈ Σ} {Ψ}_{s}^{r} ∘ {Φ}_{a}^{s} .$$

Our main interest is the special case of an adaptive sequence of quantum measurements.

A quantum computation for us is specified by a sequence of parametrized instruments Φ₁, . . . , Φ_{N} where
each parametrized instrument has the form

$${Φ}_{i} : {Γ}_{i} \times {\sum }_{i} \to CP ( {ℋ}_{i - 1} , {ℋ}_{i} ) ,$$

the initial instrument satisfies Γ₁={*} since there are no previous measurements,
at each step Γᵢ=Σ₀×Σ₁× . . . ×Σᵢ₋₁ since the choice of instrument depends on the previous outcomes.

We will depict this adaptive process as follows

$${ℋ}_{0} {↦}^{{Φ}_{1}} {ℋ}_{1} {↦}^{{Φ}_{2}} … {↦}^{{Φ}_{N - 1}} {ℋ}_{N - 1} {↦}^{{Φ}_{N}} {ℋ}_{N}$$

Let ρ be an initial quantum state. It can be a pure state, i.e., a unit vector in [symbol] ₀, or more generally a density operator. Let ρᵢ denote the quantum state at the i-th step of the quantum algorithm. We have ρ₀=ρ and

$${ρ}_{i} = \frac{{Φ}^{s} ( {ρ}_{i - 1} )}{Tr ( {Φ}^{s} ( {ρ}_{i - 1} ) )}$$

if outcome s is observed. The probability of observing s is given by the Born rule Pr(s)=Tr(Φ^{s}(ρ_{1 . . . 1})). The whole adaptive process implements a quantum channel. We say that the adaptive sequence (Φ₁, . . . , Φ_{N}) implements the quantum channel Φ∈C( [symbol] ₀, [symbol] _{N}) if

$$Φ = {\sum }_{s ∈ {\sum }_{N}} {( {Φ}_{N} ∘ … ∘ {Φ}_{2} ∘ {Φ}_{1} )}^{s} .$$

It is also possible to define an approximate implementation with respect to a sensible distance on the space of quantum channels, e.g., the diamond norm [17].

### 4.2 the Classical Algorithm

Classical simulation algorithms based on quasi-probability distributions [1], including their purely probabilistic versions [2], rely on the same principle. In this section we abstract this principle. Before this, however, let us clarify what we mean by simulation.

Our classical simulation algorithm provides a weak simulation of a quantum circuit; see e.g., [18, 19]. Informally, a weak simulator outputs samples from the quantum probability distribution.¹ The output of a weak simulator (a sample) is therefore precisely what one would obtain from a single run of a quantum computer. On the other hand, a strong simulator outputs (an estimate of) the exact Born rule probabilities. An example of this is the classical simulation algorithm implied by the Gottesman-Knill theorem [20]. As illustrated in [18], circuits that are hard to simulate in the strong sense can sometimes be efficiently simulated in the weak sense; see also [19]. ¹Technically speaking, a weak simulator outputs samples from a probability distribution that is close to the true quantum probability distribution, where “close” is taken to be with respect to L₁ norm [19].

We now establish the formalism needed for our classical simulation algorithm. Let X be a finite set denoting the set of states. We will write D(X) for the set of probability distribution on the set of states. Our goal is to simulate quantum measurements, or more generally quantum instruments. A measurement comes with a finite outcome set 2. In the case of instruments the ambient Hilbert space may change. So in our classical simulation we allow for changing the state set. Let Y denote another set of states. A probabilistic update is a map

$$q : X \to D ( Y \times \sum ) .$$

We will write qₓ to denote the probability distribution corresponding to state x∈X. If the initial state is p∈D(X) and outcome s∈2 is observed then the classical post-measurement state is given by

$${p}^{s} ( y ) = \frac{Pr ( y , s )}{Pr ( s )}$$

$$where$$

$$Pr ( y , s ) = {\sum }_{x ∈ X} {q}_{x} ( y , s ) p ( x ) , Pr ( s ) = {\sum }_{y ∈ Y} P r ( y , s ) .$$

We will also allow an additional parametrization for the updates. A parametrized update map is a function

$$q : Γ \times X \to D ( Y \times \sum )$$

where Γ is a finite set of labels for the update maps. We will write qₐ for the update corresponding to a∈Γ.

A classical simulation algorithm consists of a sequence of sets X₀, X₁, . . . , X_{N} of states and parametrized update maps q₁, . . . , q_{N} with (Γᵢ, Σᵢ) as the set of parameters and outcomes where Γᵢ=τ₀×Σ₁ . . . ×Eᵢ₋₁. Note that the choice of the parameters reflects the dependence of the update map on the previous outcomes. As before we take De to consist of a single element. We will denote a branch of the simulation by a sequence

$${X}_{0} {↦}^{{s}_{0}} {X}_{1} {↦}^{{s}_{1}} … {↦}^{{s}_{N}} {X}_{N} .$$

Our goal is to classically simulate a single measurement step in the sequence above, or more generally a process described by an instrument Φ: Σ→CP( [symbol] , [symbol] ). In applications our state sets will be the vertices of operator-theoretic polytopes. Let P and Q be (convex) poly-topes, i.e., compact convex sets with finitely many extreme points, contained in Herm₁( [symbol] ) (trace 1 Hermitian operators) and Herm₁( [symbol] ), respectively.

Definition 4.1. We say the instrument Φ preserves the pair (P,Q) of polytopes if for all A∈P and s∈Σ, we have Tr(Φ^{s}(A))≥0 and the following two properties hold:

$$Tr ( {Φ}^{s} ( A ) ) > 0 implies \frac{{Φ}^{s} ( A )}{Tr ( {Φ}^{s} ( A ) )} ∈ Q . \qquad ( 1 )$$

$$Tr ( {Φ}^{s} ( A ) ) > 0 implies {Φ}^{s} ( A ) = 0. \qquad ( 2 )$$

Observe that this definition generalizes the following very natural situation. A channel Φ∈C( [symbol] , [symbol] ), regarded as an instrument with a single outcome, preserves (P,Q) if and only if Φ(A)∈Q for all A∈P.

Let us write V(P) for the vertex set of a polytope P. For a vertex label α the corresponding operator will be denoted by A_{α}. If Φ preserves (P,Q) then we can define an update map

$${q}_{Φ} : V ( P ) \to D ( V ( Q ) \times \sum )$$

where q_{α}=(q_{Φ})_{α} is defined by Property (1):

$${Φ}^{s} ( A ) = {\sum }_{β ∈ V ( Q )} {q}_{α} ( β , s ) {A}_{β} . \qquad ( 4 )$$

Definition 4.2. We say that the resulting classical simulation algorithm is correct if for every A∈P expressed as

$$A = {\sum }_{α ∈ V ( P )} {p}_{A} ( α ) {A}_{α} \qquad ( 5 )$$

and for s∈Σ such that Tr(Φ^{s}(A))>0 it holds that

$${p}_{A}^{s} = \frac{{Φ}^{s} ( A )}{Tr ( {Φ}^{s} ( A ) )} .$$

Theorem 4.3. If an instrument Φ preserves the pair (P,Q) of polytopes then the classical simulation algorithm is correct.

### 5 the Operator-Theoretic Polytope

The classical key is generated by using an operator-theoretic polytope. In this section we introduce this polytope and identify it with the non-signaling polytope of the Bell scenario.

Algorithm 1: Classical algorithm to simulate
a single run of a quantum computation.

Consider a sequence Φ₁,... , Φ_{N} of parametrized instruments and polytopes
P₀,... , P_{N} where each Φᵢ preserves the pair (Pᵢ₋₁, Pᵢ). Given a quantum state ρ ∈ P₀,
the classical simulation algorithm proceeds as follows:

| | |
|---|---|
| 1. | Sample from the probability distribution p_{ρ} to obtain the initial vertex α₀ ∈ |
| | V(P₀). |
| 2. | For each Φᵢ, where i = 1,... , N, sample from q_{α}_{_{i−1}}_{,Φ}_{₁} to obtain the new vertex |
| | αᵢ ∈ V(Pᵢ) and outcome sᵢ ∈ Σᵢ. |
| 3. | Output sᵢ and update the vertex αᵢ₋₁ [symbol] αᵢ. |

### 5.1 the Local Λ-Polytope

The local Λ-polytope is defined as the dual of the polytope of local stabilizer states. Therefore we begin by introducing local stabilizer states. A quantum state is called a stabilizer state if it is of the form U|0 . . . 0 [symbol] for some Clifford unitary U. We will write Sₙ for the set of n-qubit stabilizer states. The local Clifford group is the subgroup of the n-qubit Clifford group generated by the single qubit Clifford unitaries acting on each tensor factor. We also consider the subgroup H generated by the local Clifford group and the unitaries that permute the tensor factors. Local stabilizer states are precisely those stabilizer states U|0 . . . 0 [symbol] where U∈H. There are 2ⁿ×3ⁿ n-qubit local stabilizer states. We will

$${S}_{n}^{ℓ}$$

for the set of n-qubit local stabilizer states.

Definition 5.1. The local Λ-polytope is defined by

$${Λ}_{n}^{ℓ} = \{ A ∈ {Herm}_{1} ( ℋ ) : Tr ( \vert ψ 〉 〈 \vert A ) \geq 0 , ∀ \vert ψ 〉 ∈ {S}_{n}^{ℓ} \} .$$

Our main result is the operational characterization of local Λ polytopes which leads to classical simulation of universal quantum computation.

Theorem 5.2.

$${Λ}_{n}^{ℓ}$$

coincides With the largest polytope contained in Herm₁( [symbol] ) preserved by all single-qubit Pouli measurements.

By combining Theorem 4.3 and Theorem 5.2 we observe that

$${Λ}_{n}^{ℓ}$$

can be used to classically simulate the MBQC based on single-qubit, Pauli measurements. This result can be extended to destructive measurements by tracing out the measured qubit. More precisely, the pair

$$( {Λ}_{n}^{ℓ} , {Λ}_{n - 1}^{ℓ} )$$

is preserved by all destructive single-qubit. Pauli measurements. In this case the polytope gets smaller at each step of the simulation

$${Λ}_{n}^{ℓ} ↦ {Λ}_{n - 1}^{ℓ} ↦ … ↦ {Λ}_{1}^{ℓ} ↦ {A}_{0}^{ℓ} = \{ * \} .$$

Note that the Λ polytope of [2] is defined as the dual polytope with respect to Sₙ. Therefore we have

$${Λ}_{n} ⊆ {Λ}_{n}^{ℓ} .$$

There is also an analogous characterization for Λ polytopes which renders them useful for universal quantum computation,

Remark 5.3. The local Λ polytope also exists for qudit of arbitrary local dimensions and can be defined as the dual of the polytope of local qudit stabilizer states. Theorem 5.2 also holds in this case. Therefore our classical simulation algorithm generalizes to qudits.

5.2 Identification with the Bell Scenario

It is common to parametrize Pauli operators using the phase space,

$${E}_{n} = {ℤ}_{2}^{n} \times {ℤ}_{2}^{n} .$$

Every Pauli operator can be written as

$${T}_{a} = {i}^{{a}_{{X}^{\cdot a} Z}} {X}^{{( {a}_{X} )}_{1}} {Z}^{{( {a}_{Z} )}_{1}} ⊗ … ⊗ {X}^{{( {a}_{X} )}_{n}} {Z}^{{( {a}_{Z} )}_{n}}$$

where a∈Eₙ and a_{X}·a_{Z} denotes the dot product of the bit strings. Given Tₐ the projector onto the (−1)^{s}-eigenspace is defined by

$${\prod }_{a}^{s} = ( + {( - 1 )}^{s} {T}_{a} ) / 2.$$

We are primarily concerned with single-qubit Pauli operators. Let xᵢ(zᵢ) denote the bit string of whose i-th (i+n)-th) entry is 1 and the rest of its entries are 0. Also let yᵢ=xᵢ+zᵢ. Then we have Tₓ_{ᵢ}=Xᵢ, T_{y}_{ᵢ}=Yᵢ, and T_{z}_{ᵢ}=Zᵢ.

Next, we identify the local Λ polytope with a multipartite Bell scenario [21]. Let NSₙ denote the non-signaling polytope of the n-partite Bell scenario with 3 dichotomic measurements per party. We will write p to denote a point in this polytope. The i-th party can perform the measurements xᵢ, yᵢ, zᵢ with outcomes in [symbol] ₂. We will write aᵢ to refer to one of these measurements. For measurements a₁, . . . , aₙ with outcomes s₁, . . . , sₙ, we will write

$${p}_{{a}_{1} … {a}_{n}}^{{s}_{1} … {s}_{n}}$$

for the corresponding probability. There is a map

$$ϕ : {Λ}_{n}^{ℓ} \to N {S}_{n}$$

defined by sending A to the probability p given by the Born rule

$${p}_{{a}_{1} … {a}_{n}}^{{s}_{1} … {s}_{n}} = Tr ( {Π}_{{a}_{1}}^{{s}_{1}} , … , {Π}_{{a}_{n}}^{{s}_{n}} A ) . \qquad ( 6 )$$

Proposition 5.4. The map φ is an isomorphism of convex sets, i.e., a convex function that has an inverse which is also convex.

An analogous identification with the polytope of non-signaling distributions on Bell scenarios applies to the qudit case.

It is well-known that deterministic non-signaling distributions are vertices of NSₙ and the polytope defined as the convex hull of these vertices is called the Bell polytope. Its faces are given by the Bell inequalities. The deterministic non-signaling distributions are denoted by δ^{γ} where γ:{xᵢ,yᵢ,zᵢ}^{×n}→ [symbol] ₂ is the outcome assignment.

### 6 Structure of the Vertices

### 6.1 Tensor Product Structure

We will analyze our polytope

$${A}_{n}^{ℓ}$$

in the general probabilistic theories (GPT) framework. This will allow us to exploit a tensor product structure.

A GPT is specified by a state space K specified by a convex, closed, and bounded subset of real Euclidean space. To a state space we associate
a space A(K) of affine functions ƒ: K→ [symbol] ,
a cone A(K)₊ consisting of ƒ∈A(K) of positive functions, i.e., ƒ(x)≥0 for all x∈K,
a unit order given by the function 1_{K}∈A(K) constant at 1,
an effect algebra E(K) defined by ƒ∈A(K) satisfying 0≤ƒ(x)≤1 for all x∈K.

Effect algebras obtained in this way are called linear effect algebras. More abstractly, given a real vector space V and a convex pointed cone C⊆V one can define a partial order by v≥u whenever u−v∈C. Then given u∈C the interval E=[0, u] is called a linear effect algebra. It is possible to recover a state space from a linear effect algebra:

$$S ( E ) = \{ ψ ∈ {cone ( E )}^{*} : 〈 ψ , {1}_{K} 〉 = 1 \} .$$

Note that S(E(K)) can be identified with K. Our main example of a state space is the polytope

$${Λ}_{n}^{ℓ} .$$

The corresponding effect algebra

$$E ( {Λ}_{n}^{ℓ} )$$

is given by the convex cone of

$${S}_{n}^{ℓ} .$$

Given two states spaces Kᵢ and K₂, the tensor product is a certain subspace

$${K}_{1} \tilde{⊗} {K}_{2} ⊆ {A ( {K}_{1} )}^{*} ⊗ {A ( {K}_{1} )}^{*} .$$

Note that in the GPT context the tensor product is not unique. But there are two edge cases:
The minimal tensor product:

$${K}_{1} \dot{⊗} {K}_{2} = conv ( \{ x ⊗ y : x ∈ {K}_{1} , y ∈ {K}_{2} \} ) .$$

The maximal tensor product:

$${K}_{1} \hat{⊗} {K}_{2} = S ( E ( {K}_{1} ) \dot{⊗} E ( {K}_{2} ) ) where$$

$$E ( {K}_{1} ) \dot{⊗} E ( {K}_{2} ) = conv ( \{ {f}_{1} ⊗ {f}_{2} : {f}_{1} ∈ {E}_{1} , {f}_{2} ∈ {E}_{2} \} ) .$$

The general tensor product lies between these edge cases. In the case of local Λ polytopes we have

$${Λ}_{{n}_{1} + {n}_{2}}^{ℓ} = {Λ}_{{n}_{1}}^{ℓ} \hat{⊗} {Λ}_{{n}_{2}}^{ℓ} . \qquad ( 7 )$$

This immediately follows from the definition of the maximal tensor product as being the dual of the minimal tensor product of the effects. Observe that

$${S}_{{n}_{1} + {n}_{2}}^{ℓ} = \{ {\prod }_{1} ⊗ {\prod }_{2} : {\prod }_{i} ∈ {S}_{{n}_{i}}^{ℓ} \} .$$

On the other hand,

$${Λ}_{{n}_{1}}^{ℓ} \dot{⊗} {Λ}_{{n}_{2}}^{ℓ} = conv ( \{ A \text{?} ⊗ A \text{?} : A \text{?} ∈ {Λ}_{n}^{ℓ} \text{?} \} ) .$$

$$\text{?} \text{indicates text missing or illegible when filed}$$

Proposition 6.1. The tensor product A_{α1}⊗A_{α2} of the vertices A_{αi}∈

$${Λ}_{{n}_{i}}^{ℓ}$$

is a vertex of

$${Λ}_{{n}_{1} + {n}_{2}}^{ℓ} .$$

Example 6.2. The single qubit local Λ polytope has eight vertices described by

$${A}_{abc} = \frac{1}{2} ( + {( - 1 )}^{a} X + {( - 1 )}^{b} Y + {( - 1 )}^{c} Z ) .$$

For any n we can construct a vertex of the n-qubit local Λ polytope using the tensor product of single qubit vertices. More explicitly, we have the tensor decomposition

$$A \text{?} = {A}_{{a}_{1} {b}_{1} {c}_{1}} ⊗ {A}_{{a}_{2} {b}_{2} {c}_{2}} ⊗ ... ⊗ {A}_{{a}_{n} {b}_{n} {c}_{n}} \qquad ( 8 )$$

$$\text{?} \text{indicates text missing or illegible when filed}$$

where \vec{k}=(k₁, . . . , kₙ) and k=a, b, c. Later these vertices will be identified with deterministic vertices which come from a family of operators that we call locally closed.

### 6.2 Local Commutativity

First we recall some facts regarding the symplectic structure of the phase space:
There is a symplectic form [⋅,⋅]:Eₙ→ [symbol] ₂ defined by

$${T}_{a} {T}_{b} = {( - 1 )}^{[ a , b ]} {T}_{b} {T}_{a} .$$

We say a, b commutes when [a,b]=0. A subspace I⊆Eₙ is called isotropic if any pair of elements in I commutes.
The product formula

$${T}_{a} {T}_{b} = {( - 1 )}^{β ( a , b )} {T}_{a + b}$$

for commuting a, b gives a function β: Eₙ×Eₙ→ [symbol] ₂. A value assignment is a function s:I→ [symbol] ₂ that satisfies s(a +b)=s(a)+s(b)+β(a,b) for all a, b∈I.
A stabilizer projector is defined by

$${Π}_{I}^{s} = {Π}_{{a}_{1}}^{{s}_{1}} … {Π}_{{a}_{k}}^{{s}_{k}}$$

where I= [symbol] a₁, . . . , aₖ [symbol] is a isotropic subspace with basis a₁, . . . , aₖ, a value assignment s:I→ [symbol] ₂; and sᵢ=s(aᵢ). If I is maximal then the corresponding projector specifies a stabilizer state. We will write Sₙ for the set of n-qubit stabilizer states.

Next, we introduce the local version of the symplectic structure.
We call an element a∈Eₙ local if a∈{xᵢ,yᵢ,zᵢ} for some i. Any element a∈Eₙ has a unique local decomposition

$$a = {\sum }_{i = 1}^{n} {α}_{i} {a}_{i}$$

where aᵢ∈{xᵢ,yᵢ,zᵢ} if αᵢ∈ [symbol] ₂ is nonzero, and aᵢ=0 otherwise. We denote the set of local elements by

$${E}_{n}^{ℓ}$$

and the remaining non-zero elements by

$${E}_{n}^{n ℓ} .$$

Thus we have a decomposition

$${E}_{n} = \{ 0 \} ⋃ {E}_{n}^{ℓ} ⋃ {E}_{n}^{n ℓ} .$$

A Pauli operator Tₐ is called (non-) local if a is (non-) local.
Let b∈Eₙ with local decomposition

$$b = {\sum }_{i = 1}^{n} {β}_{i} {b}_{i} .$$

We say a, b locally commute if [aᵢ, bᵢ]=0 for all aᵢ, Bᵢ≠0. A subspace I⊆Eₙ is called a local isotropic if every a, b∈I locally commutes. Note that I is a local maximal isotropic if and only if it is spanned by local elements.
A stabilizer (state) projector

$${\prod }_{I}^{g}$$

is called local if I is a local (maximal) isotropic. We will write

$${S}_{n}^{ℓ}$$

for the set of local stabilizer states.
The weight w(a) of an element is the number of non-zero elements in its local decom-position. We will write E° for the set of elements of weight n.

### 6.3 Locally Closed Sets

There is an important class of well-understood vertices of Λ polytopes called the closed non-contextual (CNC) vertices [2, 22]. We introduce their local version.

Definition 6.3. A subset Ω∈Eₙ is called locally closed if 0∈Ω and a, b∈Ω locally commutes then a+b∈Ω. Let Ω be a locally closed subset. A function γ:Ω→ [symbol] ₂ is called a local value assignment if γ(a+b)=γ(a)+γ(b) for all a, b∈Ω that locally commutes. We call a locally closed set Ω together with γ a local pair.

Note that if a, b locally commutes then a +b locally commutes with a and b. The maximal locally closed subset is Eₙ itself and local value assignments on this set come from outcome assignments to local elements. That is, every outcome assignment extends to a local value assignment on the whole phase space.

Proposition 6.4. Given a local pair (Ω,γ), the operator

$${A}_{Ω}^{γ} = \frac{1}{{2}^{n}} {\sum }_{a ∈ Ω} {( - 1 )}^{γ ( a )} {T}_{a} \qquad ( 9 )$$

belongs to

$${Λ}_{n}^{ℓ} .$$

We refer to the operators associated with local pairs in Eq. (9) as locally closed operators. These operators generalize the CNC operators introduced in [22]. In the qudit case the function γ takes values in [symbol] _{d}={0, 1, . . . , d−1}. Therefore the coefficients in Eq. (9) are given by the d-th roots of unity.

In the 2-qubit case, the vertices of

$${Λ}_{2}^{ℓ}$$

are known, as the vertex enumeration problem for the corresponding non-signaling problem NS₂ is solved in [23]. By further numerical verification one observes that these vertices fall into five orbits under the action of combinatorial automorphisms of the polytope. One of the orbits correspond to deterministic vertices and representatives for the remaining four are given as follows:

$${A}_{{Ω}_{2}}^{{γ}_{2}} = \frac{1}{4} ( I + {Z}_{1} + {Z}_{2} + XX + XY + YX - YY + ZZ ) , \qquad ( 10 )$$

$${A}_{{Ω}_{3}}^{{γ}_{3}} = \frac{1}{4} ( I + {Z}_{2} + XX + XY + YX - YY + ZX + ZY ) , \qquad ( 11 )$$

$${A}_{{Ω}_{4}}^{{γ}_{4}} = \frac{1}{4} ( I + XX + XY + XZ + YX - YY + YZ + ZX + ZY + ZZ ) , \qquad ( 12 )$$

$${A}_{{Ω}_{5}}^{{γ}_{5}} = \frac{1}{4} ( I + XX + XY + XZ + YX - YY + YZ + ZX + ZY - ZZ ) . \qquad ( 13 )$$

For n-qubits, we identify two classes of locally closed vertices of

$${Λ}_{n}^{ℓ}$$

(which can be identified with NSₙ by Proposition 5.4).
1. The first class is the well-known deterministic vertices of non-signaling polytope NSₙ. These are precisely the vertices identified in Example 6.2. Such deterministic vertices have the form

$${A}_{{E}_{n}}^{γ}$$

for some local value assignment γ:Eₙ→ [symbol] ₂. When γ is linear these specialize to phase point operators used in discrete Wigner functions [24]. For any n there is a straightforward method for generating all deterministic vertices. The local value assignment γ:Eₙ→ [symbol] ₂ is defined by its image γ(aᵢ) on local Pauli elements aᵢ∈{xᵢ,yᵢ,zᵢ}. Note that there are 2³ⁿ such assignments. Value assignments on nonlocal Pauli elements are then inferred from the assignments on these local elements. To see this recall that any nonlocal Pauli element b has a decomposition in terms of local elements

$$b = {\sum }_{i = 1}^{n} {c}_{i} {a}_{i} ( {c}_{i} ∈ {ℤ}_{2} )$$

then

$$γ ( b ) = {\sum }_{i = 1}^{n} {c}_{i} γ ( {a}_{i} ) ,$$

where we used that γ(e+ƒ)=γ(e)+γ(ƒ) whenever e, ƒ∈Eₙ locally commute.
2. The second class, which we call max-weight type, comes from computational power of correlations emerging from non-locality across all partitions of the parties. According to Proposition 5 of [25], a locally closed operator of the form

$${A}_{{E}_{n}^{o}}^{γ}$$

is a vertex of NSₙ if and only if

$$γ : {ℤ}_{3}^{n} \to {ℤ}_{2}$$

is not an n-bipartite linear function. For example, the 2-qubit vertices given in Eqns (12) and (13) are of this form.

Given a locally closed operator of the form

$${A}_{{E}_{n}^{o}}^{γ} ,$$

we can determine the explicit algebraic normal form of

$$γ : {ℤ}_{3}^{n} \to {ℤ}_{2}$$

(see e.g. [25]). This function can then be checked to be an n-bipartite linear function or not. In the case of 2-qubit vertices the notion of an n-bipartite linear function amounts to simply checking if the function is linear. For the vertex of Eq. (12) we have that γ(x,y)=xy, which is nonlinear.

### 7 Update Rules

In general, the computation of update rules benefit from two structural properties of our polytope: (1) the symmetries, and (2) the tensor structure.

### 7.1 Symmetries and the Update Rules

Let us consider operators A_{α} that are in

$$V ( {Λ}_{n}^{ℓ} ) ,$$

i.e., the vertex set of the n-qubit local Λ polytope. Recall that for the measurement of a local Pauli operator Tₐ, Theorems 4.3 and 5.2 guarantee that if Tr

$$( {Π}_{a}^{r} {A}_{α} ) > 0$$

then

$${Π}_{a}^{r} {A}_{α} {Π}_{a}^{r} ∈ {Λ}_{n}^{ℓ}$$

so that

$${Π}_{a}^{r} {A}_{α} {Π}_{a}^{r} = {\sum }_{β ∈ V ( {Λ}_{n}^{ℓ} )} {q}_{α} ( β , r ) {A}_{β} , \qquad ( 14 )$$

where q_{α}(β,r) is a probability distribution. Moreover, recall also that the group H is a subgroup of the n-qubit Clifford group and that the vertices of

$${A}_{n}^{ℓ}$$

split into orbits under the action of H.

Given a representative A_{α} for a particular orbit of vertices its update under measurement of local Tₐ is given by
1. Computing the operator Πₐ^{r}A_{α}Πₐ^{r}.
2. Finding the corresponding convex decomposition on the right-hand side of Eq. (14).

The update rules for all vertices A_{V}_{_{−α}}:=VA_{α}V^{†} in the orbit [A_{α}], where V∈H, are then completely determined by the update rules for the representative A_{α}.

### 7.2 Tensor Structure and the Update Rules

Let

$${\prod }_{{a}_{1}}^{{s}_{1}}$$

be a local stabilizer projector acting on the first qubit. Let us identify Eₙ₋₁ with the subspace of Eₙ generated by x₂, . . . , xₙ, z₂, . . . , zₙ. For an arbitrary trace 1 Hermitian operator

$$A = ( {\sum }_{a} f ( a ) {T}_{a} ) / {2}^{n} ∈ {A}_{n}^{ℓ} ,$$

where ƒ:Eₙ→[−1, 1] is a function such that ƒ(0)=1, we have either ƒ(a₁)=(−1)^{s}^{₁}⁺¹, in which case Tr

$$( {\prod }_{{a}_{1}}^{{s}_{1}} A ) = 0 ,$$

or ƒ(a₁)≠(−1)^{s}^{₁}⁺¹ and

$$\begin{matrix}\frac{{Π}_{{a}_{1}}^{{s}_{1}} A {Π}_{{a}_{1}}^{{s}_{1}}}{Tr ( {Π}_{{a}_{1}}^{{s}_{1}} A )} = {Π}_{{a}_{1}}^{{s}_{1}} ⊗ \overline{A} \\ = ( \frac{1}{4} {\sum }_{i = 0}^{3} {A}_{{α}_{i}}^{( 1 )} ) ⊗ ( {\sum }_{β} p ( β ) {A}_{β}^{( n - 1 )} ) \\ = {\sum }_{β , i} \frac{p ( β )}{4} {\underbrace{{A}_{{α}_{i}}^{( 1 )} ⊗ {A}_{β}^{( n - 1 )}}}_{{A}_{i , β}^{( n )}}\end{matrix}$$

$$where$$

$$\overline{A} = \frac{1}{{2}^{n}} {\sum }_{a ∈ {E}_{n - 1}} \frac{f ( a ) + {( - 1 )}^{{s}_{1}} f ( {a}_{1} + a )}{1 + {( - 1 )}^{{s}_{1}} f ( {a}_{1} )} {T}_{a} ,$$

in the second line we consider the uniform decomposition of the stabilizer state in terms of the vertices of the facet it belongs to, and on the second factor we assume a convex decomposition of Ā in

$${A}_{n - 1}^{ℓ} .$$

The tensor product

$${A}_{i , β}^{( n )}$$

belongs to

$${Λ}_{n}^{ℓ} .$$

Thus we obtain a convex decomposition of the updated operator. In particular, by Proposition 6.1 this tensor product is a vertex of

$${Λ}_{n}^{ℓ}$$

if the operators

$${A}_{β}^{( n - 1 )}$$

are vertices. The same argument works analogously for every local measurement acting on any of the qubits. Therefore the complexity of the update rules only depend on the convex decomposition happening in the smaller (n−1)-qubit local A polytope.

### 7.3 Update Rules for Locally Closed Operators

We describe the update rules for the locally closed operators.

Let

$${E}_{n - 1}^{( i )}$$

denote the subspace of Eₙ spanned by xⱼ, zⱼ, where j≠i. A locally closed set Ω can be decomposed into pairwise disjoint subsets

$$Ω = {⋃}_{c ∈ 〈 {x}_{i} , {z}_{i} 〉} {Ω}^{( i )} ( c ) \qquad ( 15 )$$

where

$${Ω}^{( i )} ( c ) = Ω ⋂ ( c + {E}_{n - 1}^{( i )} ) .$$

For simplicity of notation we will write Ω(c) when there is no danger of confusion. Using this decomposition for c∈{xᵢ,yᵢ,zᵢ} we define a locally closed set in

$${E}_{n - 1}^{( i )}$$

by setting Ω_{c}=Ω(0)∪(c+Ω(c)). Note that we can identify

$${E}_{n - 1}^{( i )}$$

with Eₙ₋₁ by shifting the indices xⱼ, zⱼ down for j≥i+1. Then c+Ω(c) and Ω_{c} can be identified with a locally closed subset in Eₙ₋₁.

We first consider the updates rules for non-destructive measurements. In this case the update rules are precisely the CNC update rules of [22]:
1. If b∈Ω then

$${Π}_{b}^{r} {A}_{Ω}^{γ} {Π}_{b}^{r} = {δ}_{r , γ ( b )} \frac{{A}_{Ω}^{γ} + {A}_{Ω}^{γ + [ b , \cdot ]}}{2} \qquad ( 16 )$$

where [b,⋅]:Ω→ [symbol] ₂ is the local value assignment defined by a [symbol] [b,a].
2. If b∉Ω then

$${Π}_{b}^{r} {A}_{Ω}^{γ} {Π}_{b}^{r} = \frac{1}{2} {A}_{Ω \times b}^{γ \times r} \qquad ( 17 )$$

$$where$$

$$Ω \times b = {Ω}_{b} ⋃ ( b + {Ω}_{b} )$$

$$and$$

$$γ \times r = \{ \begin{matrix}γ ( a ) & a ∈ {Ω}_{b} \\ γ ( a + b ) + r & a ∈ b + {Ω}_{b}\end{matrix} .$$

Note that in the second case Ω_{b} is regarded as a subset of Eₙ, not that of Eₙ₋₁.

Our computational model (the measurement-based Pauli model) uses destructive measurements. In this case the update rules are given as below. Therein, Ω(0) and Ω_{b} are regarded as subsets of Eₙ₋₁.

Proposition 7.1. Let b∈{xᵢ,yᵢ,zᵢ} and (Ω,γ) be a local pair.
1. If b∈Ω then

$${Tr}_{i} ( {Π}_{b}^{r} {A}_{Ω}^{γ} {Π}_{b}^{r} ) = {δ}_{r , γ ( b )} {A}_{Ω ( 0 )}^{γ \vert Ω ( 0 )} . \qquad ( 18 )$$

2. If b∈Ω then

$${Tr}_{i} ( {\prod }_{b}^{r} {A}_{Ω}^{γ} {\prod }_{b}^{r} ) = \frac{1}{2} {A}_{{Ω}_{b}}^{{γ}_{b}^{r}} \qquad ( 19 )$$

where

$${ℽ}_{b}^{r} : {Ω}_{b} \to {ℤ}_{2}$$

is a local value assignment defined by

$${γ}_{b}^{r} ( a ) = \{ \begin{matrix}γ ( a ) & a ∈ Ω ( 0 ) \\ γ ( a + b ) + r & a ∈ b + Ω ( b )\end{matrix} .$$

### 8 Generating the Classical Key

Our procedure for generating the classical key is based on solving the optimization problem that provides a decomposition of the initial state

$$\vert {ψ}_{G , U} 〉 〈 {ψ}_{G , U} \vert = {\sum }_{α ∈ V ( {Λ}_{n}^{ℓ} )} p ( α ) {A}_{α} . \qquad ( 20 )$$

The optimization problem to be solved is a linear program that applies to polytopes in the space of Hermitian matrices of trace 1. For a quantum state ρ, e.g., the state above, the linear program, which is known as the phase 1 of the simplex method [26], is given by

$${min}_{p , u , v} = \{ \begin{matrix}{\sum }_{𝔞 ∈ {E}_{n}} {u}_{a} + {v}_{a} : ρ = {\sum }_{a ∈ {E}_{n}} ( {u}_{a} - {v}_{a} ) {T}_{a} + {\sum }_{α ∈ V ( {Λ}_{n}^{ℓ} )} p ( α ) {A}_{a :} {u}_{a} , \\ {v}_{a} \geq 0 ∀ a ∈ {E}_{n} , p ( α ) \geq 0 ∀ α ∈ V\end{matrix} \} . \qquad ( 21 )$$

This is also used for decompositions in other operator-theoretic polytopes (e.g., U.S. Ser. No. 17/995,068).

At current stage the vertices of

$${Λ}_{n}^{ℓ}$$

are not known, except certain subclasses. Therefore in practice we start from a known subset

$$V ⊆ V ( {Λ}_{n}^{ℓ} )$$

of vertices. However, in this case the resource quantum state may fall outside of the polytope determined by this set of vertices. This occurs when the linear program defined in Eq. (21) is infeasible, hence we obtain a quasi-probability distribution in the expansion given by Eq. (20). That is, we still have Σ_{α}p(α)=1, but some of the p(α)'s can be negative so that the L₁ norm

$${‖ p ‖}_{1} = {\sum }_{α ∈ V} \vert p ( α ) \vert$$

satisfies ∥p∥₁≥1 with strict equality occurring if and only if p(α) is a true probability distribution. To obtain a valid quasi-probability distribution in the first place it suffices to solve the linear system

$$Tr ( {T}_{a} ρ ) = {\sum }_{α ∈ V} p ( α ) Tr ( {T}_{a} {A}_{α} ) subject to {\sum }_{α ∈ V} p ( α ) = 1.$$

This can be done, for example, by Gaussian elimination.

When quasiprobabilities arise the simulation can still run using the method in [27]. This can be done by modifying the quasiprobability distribution p:V→ [symbol] to obtain a proper probability distribution \tilde{p}:V→ [symbol] _{≥0} defined by \tilde{p}(α)=|p(α)|/∥p∥. An optimal quasi-probability distribution can then be chosen and modified in this way to obtain a probability distribution which can be need to initiate the simulation algorithm. In this case the optimization problem to be solved is

$${V}_{} ( ρ ) = {min}_{p} \{ {‖ p ‖}_{1} : ρ = {\sum }_{α ∈ V} p ( α ) {A}_{α} \} . \qquad ( 22 )$$

The quantity [symbol] _{V}(ρ) is called the robustness measure, and it determines the hardness of the simulation [22].

The easiest case is when the graph G has no edges, indicating that there are no entangling operations applied to the product state |ψ_{U} [symbol] =T^{⊗U}|+ [symbol] ^{⊗n}. Proposition 6.1 (or simply the fact that tensor product of deterministic vertices give a deterministic vertex) implies that it suffices to decompose |+ [symbol] and |T [symbol] states in the 1-qubit local Λ polytope. We have

$$\vert + 〉 〈 + \vert = \frac{1}{4} {\sum }_{( c , d ) ∈ {ℤ}_{2}^{2}} {A}_{0 cd} \\ and \\ \vert T 〉 〈 T \vert = \frac{1}{2} ( \frac{1}{\sqrt{2}} {A}_{000} + {A}_{010} + ( 1 - \frac{1}{\sqrt{2}} ) {A}_{101} ) . \qquad ( 23 )$$

Then |ψ_{U} [symbol] can be described as a probabilistic mixture of deterministic locally closed vertices by computing the tensor product of the individual decompositions. The update rules can be computed efficiently following Proposition 7.1. Therefore we obtain the following consequence.

Corollary 8.1. If in the initial state |ψ_{G,U} [symbol] _{the graph G does not have any edges, i.e., the initial state is a product state constructed from single qubit |+} [symbol] _{and |T} [symbol] _{states, then the classical simulation algorithm based on the local Λ polytope is efficient.}

The entanglement operation, more precisely E(G) given by a product of controlled-Z's, can move the deterministic vertices outside the local Λ polytope. Therefore the decomposition for the product state |ψ_{U} [symbol] does not immediately help with that of |ψ_{G,U} [symbol] _{.}

Example 8.2. To decompose |ψ [symbol] =E₁₂|++ [symbol] we can proceed as follows:

$$\begin{matrix}\vert ψ 〉 〈 ψ \vert = {E}_{12} ( {\prod }_{{x}_{1}}^{0} ⊗ {\prod }_{{x}_{2}}^{0} ) {E}_{12} \\ = \frac{1}{4} ( + XZ + ZX + YY ) \\ = \frac{1}{4} ( {\underbrace{{A}_{011} ⊗ {A}_{110}}}_{{A}_{{α}_{0}}} + {\underbrace{{A}_{101} ⊗ {A}_{101}}}_{{A}_{{α}_{1}}} + {\underbrace{( {A}_{000} ⊗ {A}_{000} )}}_{{A}_{{α}_{2}}} + {\underbrace{{A}_{110} ⊗ {A}_{011}}}_{{A}_{{α}_{3}}} )\end{matrix}$$

where we use the notation in Eq. (8).

Another way to approach this is to use the CNC vertices of the Λ polytope to obtain a decomposition. The procedure runs as follows:
First decompose |ψ_{U} [symbol] in terms of the Λ CNC vertices:

$$\vert {ψ}_{U} 〉 〈 {ψ}_{U} \vert = {\sum }_{β} q ( β ) {\tilde{A}}_{β} .$$

Then act by E(G) to obtain a decomposition of |ψ_{G,U} [symbol] in terms of the CNC vertices:

$$\vert {ψ}_{G , U} 〉 〈 {ψ}_{G , U} \vert = {\sum }_{β} q ( β ) {\underbrace{E ( G ) {\tilde{A}}_{β} E ( G )}}_{{\tilde{A}}_{β}^{′}} .$$

where

$${\tilde{A}}_{β}^{′}$$

are still CNC vertices of Λₙ.
The key step is to decompose each

$${\tilde{A}}_{β}^{′}$$

that appears in the decomposition above in terms of the locally closed vertices:

$${\tilde{A}}_{β}^{′} = {\sum }_{α} {p}_{β} ( α ) {A}_{α} .$$

Note that there are cases where

$${\tilde{A}}_{β}^{′} ’ s$$

turn out to be vertices of the local Λ polytope. Thus this step is sometimes trivial.
Combining these steps gives

$$\vert {ψ}_{G , U} 〉 〈 {ψ}_{G , U} \vert = {\sum }_{α} ( {\underbrace{{\sum }_{β} q ( β ) {p}_{β} ( α )}}_{p ( α )} ) {A}_{α}$$

This method works well for small number of qubits.

Example 8.3. Assume that U={1}, or more generally a vertex subset consisting of a single element. Then we can find a CNC decomposition as follows

$$\begin{matrix}{\vert {ψ}_{G , U} 〉 〈 {ψ}_{G , U} \vert = E ( G ) ( \vert T 〉 〈 T \vert ⊗ ( \vert + 〉 〈 + \vert )}^{⊗ ( n - 1 )} ) E ( G ) \\ = \frac{1}{2} ( \frac{1}{\sqrt{2}} {\underbrace{E ( G ) ( {A}_{000} ⊗ \prod ) E ( G )}}_{{A}_{{β}_{0}}} + {\underbrace{E ( G ) ( {A}_{010} ⊗ \prod ) E ( G )}}_{{A}_{{β}_{1}}} + \\ ( 1 - \frac{1}{\sqrt{2}} ) {\underbrace{E ( G ) ( {A}_{101} ⊗ \prod ) E ( G )}}_{{A}_{{β}_{2}}} ) \\ = \frac{1}{2} ( \frac{1}{\sqrt{2}} {A}_{{β}_{0}} + {A}_{{β}_{1}} + ( 1 - \frac{1}{\sqrt{2}} ) {A}_{{β}_{2}} )\end{matrix}$$

where Π=(|+ [symbol] +|)^{⊗(n-1)}. It is known that the tensor product of a CNC vertex with a stabilizer state is a CNC vertex [28].

In the T-gate implementation we will use the state with n=3. In this case numerical computation shows that A_{β}_{ᵢ}'s are also locally closed vertices. We will need i=0 in Example 9.2:

$${A}_{{β}_{0}} = \frac{1}{8} ( + ZYY + YIX + ZXZ + XZI + ZZX + ZII + YYZ + IYY + XXY + YZI + IXZ + IZX + XIX - YXY - XYZ ) . \qquad ( 24 )$$

### 8.1 Efficiently Simulatable Region

In practice we sometimes don't have a description of the vertices of our operator-theoretic polytope, but only a limited class of points inside the polytope that we know how to update. In this case our classical simulation algorithm can still run. To this end, we introduce a modified version of our algorithm. This way we can sometimes simulate efficiently a larger class of quantum states.

The modification is minor and is standard for sampling algorithms based on operator-theoretic polytopes; see [29]. Let X⊆P and Y⊆Q be finite sets such that P and Q are operator-theoretic polytopes given by the convex hull of these subsets. These sets necessarily contain the vertices. Given Φ that preserves the pair (P,Q) we can define an update map

$${q}_{Φ} : X \to D ( Y \times \sum )$$

using Eq. (4) that follows from Property (1). We need to verify that the classical simulation algorithm based on this new update map is correct in the sense of Definition 4.2. This verification is exactly the same as the proof of Theorem 4.3.

We can define the locally closed polytope, denoted by

$${Λ}_{n}^{ℓC} ,$$

to be the convex hull of locally closed operators. The structure of locally closed sets is much richer than the CNC sets. A general classification result is currently out of reach. Since locally closed operators are much more complicated than CNC operators we cannot immediately conclude that quantum states that fall in

$${Λ}_{n}^{ℓC}$$

can be efficiently simulated. The main challenge is to represent local pairs with polynomial memory.

We can show that an initial state |ψ_{G,U} [symbol] where U is the empty set, (graph state) does not yield any computational power. This observation relies on the fact that any CNC set, which in particular is a local pair, can be represented with polynomial memory. The efficiency of the update rules follow similar to the CNC case. For the representation let

$${A}_{Ω}^{ℽ}$$

be a CNC vertex. By the classification of maximal CNC sets, Ω=I₁∩ . . . ∩I₂ₘ₊₁ where 0≤m≤n, Iᵢ= [symbol] aᵢ, I [symbol] for some isotropic Ĩ of dimension n−m and set {a₁, . . . , a₂ₘ₊₁} of pairwise anti-commuting elements. Each pair (Iᵢ,γ|_{I}_{ᵢ}) corresponds to a stabilizer code which can be efficiently represented by the tableau method of the Gottesman-Knill simulation [3]. Since a CNC vertex is essentially a union of a polynomial number (more specifically O(n)) of stabilizer codes, it can be efficiently represented by this method. Moreover, the updates are also efficient in the non-destructive case as shown in [22]. For destructive measurements, the tableau representation still works. The updated operator is still a CNC operator (not necessarily a vertex), hence can still be represented efficiently. This construction extends the region of efficiently simulatable quantum states beyond the known boundary as determined in [22,30].

### 9 The procedure

In this section we are going to describe the procedure in detail and give explicit examples.

Algorithm 2: Protocol for performing polytope-based classical simulation.

```
Consider a circuit [symbol]  which we assume to be given in the Clifford + T basis.
  1. Convert from the circuit model to the MBPC model.
    (a) Construct the corresponding graph G and subset U, extract qubit count
        n.
  $2. Enumerate a subset of vertices V ⊆ V ( {Λ}_{n}^{ℓ} ) .$
  3. Calculate the update rules for representatives of vertex orbits in V.
  4. Find a decomposition (convex or affine) of the initial state |ψ_{G,U} [symbol] ψ_{G,U}|.
  5. Run the classical simulation algorithm involving adaptive local Pauli measure-
    ments.
```

The steps involved in performing a polytope-based classical simulation are given in Algorithm 2. The MBPC computational model is explained in Section 3 and the local A polytope is introduced in Section 5. For the classical simulation in part (5) we will use Algorithm 4 (non-destructive measurements) and Algorithm 3 (destructive measurements). Also note that the notation used in the algorithms are introduced in Section 6 and Section 7. These algorithms are the two versions obtained from the general version Algorithm 1 for a particular class of vertices of the local Λ polytope. Note that in step (2) of Algorithm 2 we don't need to restrict to vertices. For example, locally closed operators represented by local pairs are not necessarily vertices. Below, we present both a pseudocode representation, and a detailed verbal description for Algorithms 3 (non-destructive measurements) and 4 (destructive measurements).

### Verbal Description of the Algorithms:

### 1. Initialization

Given that the initial state is expressed as a convex combination of locally closed operators, both algorithms begin by sampling one of these operators, with the probability of selecting each operator determined by its corresponding coefficient in the convex combination. The sampled operator is then set as the current state.

### 2. Measurement

For each measurement, there are two possible scenarios, similar to those encountered in stabilizer state simulation: the deterministic case and the probabilistic case. If the expectation value of the current state with respect to the measured local Pauli operator is +1 or −1, we proceed with the deterministic case; if the expectation value is 0, we proceed with the probabilistic case. The outputs and updates for each scenario in both algorithms are as follows:

### (a) Non-Destructive Case

### Deterministic Case for Algorithm 3

The measurement outcome is determined the expectation value of the current state with respect to the measured Pauli operator. If the expectation is value +1, the outcome is 0; if the expectation value is −1, the outcome is 1. To update the current state, we flip a fair coin: if it lands heads, the state remains unchanged; if it lands tails, we update the state by flipping the sign of the expectation values (1→−1 and −1→1) of the expectation values of the Pauli operators that do not commute with the measured Pauli operator in the current state.

### Probabilistic Case for Algorithm 3

We flip a fair coin and assign the outcome as 0 for heads and 1 for tails. To update the current state, Pauli operators that do not commute with the measured Pauli operator are removed, while those that commute are retained with their signs unchanged. Additionally, new Pauli operators, formed by multiplying the measured Pauli operator with the retained operators, are added to the current state. The expectation values of the current state with respect to these new Pauli operators are determined by multiplying the expectation value of the corresponding retained Pauli operator by −1 raised to the power of the coin flip outcome (0 or 1).

### (b) Destructive Case

### Deterministic Case for Algorithm 4

The measurement outcome is determined by the expectation value of the current state with respect to the measured Pauli operator. If the expectation value is +1, the outcome is 0; if the expectation value is −1, the outcome is 1. To update the current state, all Pauli operators that do not act trivially on the measured qubit are removed. Additionally, the measured qubit is removed from all remaining Pauli operators, reducing the number of qubits by 1.

### Probabilistic Case for Algorithm 4

We flip a fair coin and assign the outcome as 0 for heads and 1 for tails. To update the current state, Pauli operators that do not commute with the measured Pauli operator are removed, while those that commute are retained. We do not change the expectation values of the current state with respect to Pauli operators if the outcome is 0. However, if the outcome is 1, we flip the sign of the expectation values (1→−1 and −1→1) of the current state with respect to the Pauli operators that does not act trivially on the measured qubit. Additionally, the measured qubit is removed from all remaining Pauli operators, reducing the number of qubits by 1.

We repeat this measurement process for n measurements, where n is the number of qubits in the initial system, to obtain the final output.

### 3. Code Implementation

To implement these algorithms in code, we can assign a numbering scheme to the Pauli operators (i.e. lexicographical ordering of the Pauli operators), which allows us to store the current state as a vector of expectation values with respect to each Pauli operator. The updates to this state can then be applied directly, as outlined in the algorithms.

Next, we describe the implementation of our procedure using examples. Our computational model is described in Section 3. The so-called local Λ polytope, used in generating the classical key is described in Section 5. Further technical details of the key generation procedure are described in Section 8. We demonstrate how those results are applied to run the procedure. We begin with a deterministic computation.

Example 9.1. 1. Circuit. The first system wants to simulate the circuit
where |+ [symbol] =H|0 [symbol] . This circuit outputs s=0 deterministically.
2. Conversion to MBPC. The first system converts this circuit to our computational model, which consists of a sequence of single-qubit Pauli measurements. This can be achieved by using the MBQC implementation of H given in Eq. (2) and commuting all the Pauli corrections pass the measurements. This step collects the corrections at the end of the circuit, which can be ignored since they don't affect the measurement statistics:

Algorithm 3: Classical algorithm to simulate quantum states that are in the convex hull
of local pairs with non-destructive measurements.

```
Consider an initial quantum state ρ which can be written as a convex sum of local
pairs
$ρ = {{\sum }_{( Ω , γ )}}_{local pair} {p}_{ρ} ( Ω , γ ) {A}_{Ω}^{γ}$
where p_{ρ}, is a probability distribution and sequence of measurements of local Pauli
operators T_{b}_{₁}, ... ,T_{b}_{_{N}}.
  1. Sample a local pair (Ω⁽⁰⁾, γ⁽⁰⁾) from the probability distribution p_{ρ}.
  2. For i = 1 to N:
    (a) Set Ω := Ω⁽ⁱ⁻¹⁾ and γ := γ⁽ⁱ⁻¹⁾.
    (b) If bᵢ ∈ Ω, then give output sᵢ := γ(b) and set Ω⁽ⁱ⁾ := Ω. Then flip a fair
        coin. If “heads” set γ⁽ⁱ⁾ := γ and if “tails” set γ⁽ⁱ⁾ := γ + [b, · ].
    (c) If bᵢ ∉ Ω then flip a fair coin. If “heads” give output sᵢ := 0 and if “tails”
        give output sᵢ := 1. Then set Ω⁽ⁱ⁾ := Ω × b, γ⁽ⁱ⁾ := γ × sᵢ.
```

Algorithm 4: Classical algorithm to simulate quantum states that are in the convex hull
of local pairs with destructive measurements.

```
Consider an initial quantum state ρ which can be written as a convex sum of local
pairs
$ρ = {{\sum }_{( Ω , γ )}}_{local pair} {p}_{ρ} ( Ω , γ ) {A}_{Ω}^{γ}$
where p_{ρ} is a probability distribution and sequence of measurements of local Pauli
operators T_{b}_{₁}, ... ,T_{b}_{_{N}}.
  1. Sample a local pair (Ω⁽⁰⁾, γ⁽⁰⁾) from the probability distribution p_{ρ}.
  2. For i = 1 to N:
    (a) Set Ω := Ω⁽ⁱ⁻¹⁾ and γ := γ⁽ⁱ⁻¹⁾.
    (b) If bᵢ ∈ Ω, then give output sᵢ := γ(b) and set Ω⁽ⁱ⁾ := Ω(0), γ⁽ⁱ⁾ := γ|_{Ω(0)}.
    (c) If bᵢ ∉ Ω then flip a fair coin. If “heads” give output sᵢ := 0 and if “tails”
        $give output {s}_{i} := 1. Then set {Ω}^{( i )} := {Ω}_{b} , {γ}^{( i )} := {γ}_{b}^{{s}_{i}} .$
```

The computation is implemented by first initiating the system at the state |ψ_{G} [symbol] =E₁₂|++ [symbol] , and applying X₁ measurement and then applying Z₂ or −Z₂ measurement, depending on the outcome of the first measurement. Similarly this circuit outputs s₂=0 deterministically.
3. Generation of the key. The first system passes a classical description of the graph G=(V,E) with vertex set V={1,2} and edge set E={e₁₂} (together with U =∅) to the second system. The second system solves the linear optimization problem (either on a supercomputer or a quantum computer) to generate the probability distribution describing the key K(G). The initial state is a uniform mixture of the vertices {A_{α}_{ᵢ}: i=0, 1, 2,3} described in Example 8.2. Each αᵢ can be described by 6 bits (a₁, b₁, c₁, a₂, b₂, c₂)∈ [symbol] . The second system passes one of the vertices, say α₀=(0,1,1,1,1,0), to the first system:
Since the original circuit is deterministic it suffices to pass a single sample.
4. Classical simulation (non-destructive). The first system receives a classical description of α₀ from the second system and simulates the quantum computation by using the update rules. To compute the update we will use Eq. (16). For the X₁ measurement:
   with probability ½ the vertex stays at α₁=α₀ and the simulation outputs s₁=0,
   with probability ½ the vertex updates to α₁=(0,0,0,1,1,0) and the simulation outputs s₁=0:
Assume that the latter case happens, i.e., α₀ is updated to α₁=(0,0,0,1,1,0) with output s₁=0. Then for the Z₂ measurement:
with probability ½ the vertex stays at α₂=α₁ and the simulation outputs s₂=0,
with probability ½ the vertex updates to α₂=(0,0,0,0,0,0) and the simulation outputs s₂=0:
Assume that the latter case happens. The vertex is updated to α₂=(0,0,0,0,0,0) with output s₂=0, and the algorithm terminates.
4′. Classical simulation (destructive). For the destructive case we use Eq. (18). For the X₁ measurement:
the vertex deterministically updates to α₁=(1,1,0) and the simulation outputs s₁=0.
For the Z₂ measurement:
   the vertex deterministically updates to α₂=* and the simulation outputs s₂=0.

Comparing the computational branches of the destructive and non-destructive cases we observe that both simulations agree.

Our next example is a probabilistic computation.

Example 9.2. 1. Circuit. The circuit to be simulated is
This circuit outputs s=0 with probability ½.
2. Conversion to MBPC. The first system converts to the three-qubit circuit (by using Eq. (3) and commuting the corrections pass the measurements):
3. Generation of the key. The first system passes a classical description of the pair (G,U) to the second system. Here G=(V,E) is the graph with vertex set V={1, 2} and edge set E={e₁₂}. The vertex subset U is {1}. The key K(G,U) is a probability distribution on the vertices (A_{β}_{₀}, A_{β}_{₁}, A_{β}_{₂}) with values

$$( \frac{1}{2 \sqrt{2}} , \frac{1}{2} , \frac{\sqrt{2} - 1}{2 \sqrt{2}} )$$

as obtained in Example 8.3. Each vertex is a CNC Λ vertex. By computer verification we know that these are also local Λ vertices. The second system passes a classical description of one of these vertices, say A_{β}_{₀} in Eq. (24), to the first system. The initial classical key α₀=β₀ representing the CNC vertex is a graph whose vertices are labeled by Pauli operators and signs ±:
This representation is a visual aid to the usual representation of CNC vertices as unions of isotropic subspaces; see [22].
4. Classical simulation (non-destructive). The first system receives a classical description of α₀ from the second system. Let us simulate the computational branch given by s₁=0, s₂=0 and s₃=0. For the X₁ measurement (using Eq. (17)):
   with probability ½ the simulation outputs s₁=0, and α₀ updates to the state α₁:
   This represents the tensor product of a single qubit vertex and a 2-qubit vertex.
For the X₂ measurement (using Eq. (16)):
   with probability ½ the simulation outputs s₂=0, and α₁ updates to the state α₂:
   a tensor product of single qubit vertices.
For the final measurement Z₃ (using Eq. (16)) we see that the outcome is deterministically s₃=0. Other computational branches can be computed similarly.
4′. Classical simulation (destructive). The computational branch given by s₁=s₂=s₃=0 in the destructive case can be computed using Proposition 7.1. For the X₁ measurement (using Eq. (19)):
   the vertex deterministically updates to α₁ given by the right-hand tensor factor of the non-destructive case.
For the X₂ measurement (using Eq. (18)):
   the vertex deterministically updates to α₂ given by the last tensor factor of the non-destructive case.
Finally the Z₃ measurements updates the vertex to α₃=*, and the algorithm terminates.

Comparing the destructive and non-destructive versions of the algorithm, we observe that the destructive version carries less data and is, therefore, more efficient.

### REFERENCES

[1] V. Veitch, C. Ferrie, D. Gross, and J. Emerson, “Negative quasi-probability as a resource for quantum computation,” New Journal of Physics, vol. 14, no. 11, p. 113011, 2012.
[2] M. Zurel, C. Okay, and R. Raussendorf, “Hidden variable model for universal quantum computation with magic states on qubits,” Physical Review Letters, vol. 125, no. 26, p. 260404, 2020.
[3] S. Aaronson and D. Gottesman, “Improved simulation of stabilizer circuits,” Physical Review A, vol. 70, no. 5, p. 052328, 2004.
[4] M. A. Nielsen and I. L. Chuang, Quantum computation and quantum information, vol. 2. Cambridge university press Cambridge, 2001.
[5] S. Bravyi and A. Kitaev, “Universal quantum computation with ideal clifford gates and noisy ancillas,” Physical Review A, vol. 71, no. 2, p. 022316, 2005.
[6] S. Bravyi, G. Smith, and J. A. Smolin, “Trading classical and quantum computational resources,” Physical Review X, vol. 6, no. 2, p. 021043, 2016.
[7] F. C. Peres and E. F. Galvāo, “Quantum circuit compilation and hybrid computation using pauli-based computation,” Quantum, vol. 7, p. 1126, 2023.
[8] F. C. Peres, “Pauli-based model of quantum computation with higher-dimensional systems,” Physical Review A, vol. 108, no. 3, p. 032606, 2023.
[9] R. Raussendorf and H. J. Briegel, “A one-way quantum computer,” Physical review letters, vol. 86, no. 22, p. 5188, 2001.
[10] D. Zhou, B. Zeng, Z. Xu, and C. Sun, “Quantum computation based on d-level cluster state,” Physical Review A, vol. 68, no. 6, p. 062303, 2003.
[11] V. Danos and E. Kashefi, “Pauli measurements are universal,” Electronic Notes in Theoretical Computer Science, vol. 170, pp. 95-100, 2007.
[12] J. Bermejo-Vega, N. Delfosse, D. E. Browne, C. Okay, and R. Raussendorf, “Contextuality as a resource for models of quantum computation with qubits,” Physical review letters, vol. 119, no. 12, p. 120505, 2017.
[13] V. Danos, E. Kashefi, and P. Panangaden, “The measurement calculus,” Journal of the ACM (JACM), vol. 54, no. 2, pp. 8-es, 2007.
[14] R. Raussendorf, “Contextuality in measurement-based quantum computation,” Physical Review A, vol. 88, no. 2, p. 022322, 2013.
[15] J. Anders and D. E. Browne, “Computational power of correlations,” Physical Review Letters, vol. 102, no. 5, p. 050502, 2009.
[16] J. Watrous, The theory of quantum information. Cambridge university press, 2018.
[17] D. Aharonov, A. Kitaev, and N. Nisan, “Quantum circuits with mixed states,” in Proceedings of the thirtieth annual ACM symposium on Theory of computing, pp. 20-30, 1998.
[18] M. Van Den Nes, “Classical simulation of quantum computation, the gottesman-knill theorem, and slightly beyond,” Quantum Information & Computation, vol. 10, no. 3, pp. 258-271, 2010.
[19] H. Pashayan, S. D. Bartlett, and D. Gross, “From estimation of quantum probabilities to simulation of quantum circuits,” Quantum, vol. 4, p. 223, 2020.
[20] D. Gottesman, “Group22: Proceedings of the xxii international colloquium on group theoretical methods in physics,” 1999.
[21] N. Brunner, D. Cavalcanti, S. Pironio, V. Scarani, and S. Wehner, “Bell nonlocality,” Reviews of modern physics, vol. 86, no. 2, p. 419, 2014.
[22] R. Raussendorf, J. Bermejo-Vega, E. Tyhurst, C. Okay, and M. Zurel, “Phase-space-simulation method for quantum computation with magic states on qubits,” Physical Review A, vol. 101, no. 1, p. 012350, 2020.
[23] N. Jones and L. Masanes, “Interconversion of nonlocal correlations,” Physical Review A, p. 43-73, 2005.
[24] R. Raussendorf, D. E. Browne, N. Delfosse, C. Okay, and J. Bermejo-Vega, “Contextuality and wigner-function negativity in qubit quantum computation,” Physical Review A, vol. 95, no. 5, p. 052334, 2017,
[25] M. J. Hoban, J. J. Wallman, and D. E. Browne, “Generalized bell-inequality experiments and computation,” Physical Review A, vol. 84, no. 6, p. 062107, 2011.
[26] V. Chvátal, Linear programming. Macmillan, 1983.
[27] H. Pashayan, J. J. Wallman, and S. D. Bartlett, “Estimating outcome probabilities of quantum circuits using quasiprobabilities,” Physical review letters, vol. 115, no. 7, p. 070501, 2015.
[28] C. Okay, M. Zurel, and R. Raussendorf, “On the extremal points of the Lambda-polytopes and classical simulation of quantum computation with magic states,” arXiv preprint arXiv: 2104.05822, 2021.
[29] M. Zurel and A. Heimendahl, “Efficient classical simulation of quantum computation beyond wigner positivity.” arXiv preprint arXiv: 2407.10349, 2024.
[30] M. Zurel, C. Okay, R. Raussendorf, and A. Heimendahl, “Hidden variable model for quantum computation with magic states on any number of qudits of any dimension,” arXiv preprint arXiv: 2110.12318, 2021.
[31] D. Klyshko, “The Bell theorem and the problem of moments,” Physics Letters A, vol. 218, no. 3-6, pp. 119-127, 1996.
[32] M. Plávala, “General probabilistic theories: An introduction,” Physics Reports, vol. 1033, pp. 1-64, 2023.
   A Conjugation with Stabilizer Projectors

Consider a Hermitian operator A acting on [symbol] ₙ=( [symbol] ²)^{⊗n} expressed in the Pauli basis

$$A = \frac{1}{{2}^{n}} {\sum }_{{E}_{n}} {α}_{a} {T}_{a} , {α}_{a} ∈ ℝ .$$

Lemma A.1.

$$Let {\prod }_{b}^{s} = ( + {( - 1 )}^{s} {T}_{b} ) / 2 be a stabilizer projector .$$

We have

$${\prod }_{b}^{s} A {\prod }_{b}^{s} = \frac{1}{{2}^{n}} {\sum }_{a ∈ {〈 b 〉}^{⊥}} \frac{{α}_{a} + {( - 1 )}^{s + β ( a , b )} {α}_{a + b}}{2} {T}_{a} .$$

Proof. This follows from the computation

$$\begin{matrix}{\prod }_{b}^{s} {T}_{a} {\prod }_{b}^{s} = \frac{+ {( - 1 )}^{s} {T}_{b}}{2} {T}_{a} \frac{+ {( - 1 )}^{s} {T}_{b}}{2} \\ = \frac{1}{4} ( {T}_{a} + {( - 1 )}^{s} {T}_{a} {T}_{b} + {( - 1 )}^{s} {T}_{b} {T}_{a} + {T}_{b} {T}_{a} {T}_{b} ) \\ = ( {T}_{a} + {( - 1 )}^{s + β ( a , b )} {T}_{a + b} ) / 2\end{matrix}$$

if [a, b]=0, and zero otherwise. Now using this computation and the identity β(a +b,b)=β(a,b) we can conjugate X and collect the coefficients of Tₐ's to obtain the desired result.

[symbol]

Given value assignment s:I→ [symbol] ₂ and r:J→ [symbol] ₂ that satisfy s|_{I∩J}=r|_{I∩J}, we write s*r:I+J→ [symbol] ₂ for the unique value assignment whose restriction to I and J coincide with s and r, respectively. Then using the lemma we obtain the following.

Corollary A.2. We have

$${\prod }_{I}^{s} {\prod }_{J}^{r} {\prod }_{I}^{s} = {δ}_{{s {\vert}_{I ⋂ J} , r \vert}_{I ⋂ J}} \frac{\vert {I}^{⊥} ⋂ J \vert}{\vert J \vert} {\prod }_{I + {I}^{⊥} ⋂ J}^{s * ( r {\vert}_{{I}^{⊥} ⋂ J} )} .$$

B Proofs of the technical results

### B.1 Proof of Theorem 4.3

Proof. Consider the expression in Eq. (5). We have

$$\begin{matrix}{Φ}^{s} ( A ) = {\sum }_{α ∈ V} {p}_{A} ( α ) {Φ}^{s} ( {A}_{α} ) \\ = {\sum }_{α : Tr ( {Φ}^{s} ( {A}_{α} ) ) > 0} {p}_{A} ( α ) {\sum }_{β} {q}_{α} ( β , s ) {A}_{β} \\ = {\sum }_{β} {\sum }_{α : Tr ( {Φ}^{s} ( {A}_{α} ) ) > 0} {q}_{α} ( β , s ) {p}_{A} ( α ) {A}_{β} \\ = {\sum }_{β} Pr ( β , s ) {A}_{β}\end{matrix}$$

where Property (1) and Property (2) are used in the second equality.

[symbol]

### B.2 Proof of Theorem 5.2

Let us write

$${P}_{n}^{ℓ}$$

for the maximal polytope in the statement of the theorem. More explicitly, it consists of A∈Herm₁( [symbol] ) such that for all local Pauli Tₒ, Tr

$$( {\prod }_{a}^{s} A ) \geq 0$$

and
1. Tr

$$( {\prod }_{a}^{s} A ) > 0$$

implies

$$\frac{{\prod }_{a}^{s} A {\prod }_{a}^{s}}{Tr ( {\prod }_{a}^{s} A )} ∈ {P}_{n}^{ℓ} , \qquad ( 25 )$$

2. Tr

$$( {\prod }_{a}^{s} A ) = 0$$

implies

$${\prod }_{a}^{s} A {\prod }_{a}^{s} = 0. \qquad ( 26 )$$

Lemma B.1. Local stabilizer states probabilistically update to local stabilizer states under local Pauli measurements.

Proof. Using Corollary A.2 for any maximal isotropic I and Pauli element b∈E we have

$${\prod }_{b}^{r} {\prod }_{I}^{s} {\prod }_{b}^{r} = {δ}_{s ( b ) , r} \frac{\vert {〈 b 〉}^{⊥} ⋂ I \vert}{\vert I \vert} {\prod }_{I ( b )}^{s * r} \qquad ( 27 )$$

where I(b):={a+b:a∈ [symbol] b [symbol] ^{⊥}∩I}. Consider the special case where I= [symbol] a₁, . . . , aₙ [symbol] is a local maximal isotropic and b=bⱼ is a local Pauli element. If bⱼ∈I then I(bⱼ)=I. Moreover, if s(b)=r then s*r=s and we return the same local stabilizer state. Otherwise if s(bⱼ)≠r the expression vanishes. If instead we have that bⱼ∉I we return the new stabilizer state

$${Π}_{I ( {b}_{j} )}^{\text{?}}$$

$$\text{?} \text{indicates text missing or illegible when filed}$$

with probability ½. To see that

$${Π}_{I ( {b}_{j} )}^{\text{?}}$$

$$\text{?} \text{indicates text missing or illegible when filed}$$

is itself another local stabilizer state, note that bⱼ must anticommute with aⱼ. The new maximal isotropic I(b)= [symbol] a₁, . . . , aⱼ₋₁, bⱼ, aⱼ₊₁; . . . ; aₙ [symbol] is, by definition, a local stabilizer state.

[symbol]

Lemma B.2. The set of local stabilizer states spans the set of Hermitian operators.

Proof. Notice first that any b∈Eₙ can be written as

$$b = {\sum }_{i = 1}^{n} {c}_{i} {a}_{i}$$

wherein aᵢ∈{xᵢ,yᵢ,zᵢ} and cᵢ∈ [symbol] ₂. This implies that every b∈Eₙ must appear in some local maximal isotropic I. Now let b∈I, where I is a local isotropic. Since we have

$${\prod }_{I}^{s} = \frac{1}{{2}^{n}} {\sum }_{a ∈ I} {( - 1 )}^{s ( a )} {T}_{a} ,$$

it is possible to solve for T_{b} using

$${( - 1 )}^{s ( b )} {T}_{b} = {( - 1 )}^{s ( b )} {\sum }_{{s}^{′} : {s}^{′} ( b ) = s ( b )} {\prod }_{I}^{{s}^{′}} .$$

We can do this for all b∈Eₙ and since Pauli operators span the space of Hermitian operators, so too do

$$\{ {\prod }_{I}^{s} \} .$$

[symbol]

More technically, local stabilizer states form an overcomplete basis (or frame) for Hermitian operators. We will use these two lemmas in the proof of our main theorem.

Proof of Theorem 5.2. First we prove that

$${Λ}_{n}^{ℓ} ⊆ {P}_{n}^{ℓ} . Let A ∈ {Λ}_{n}^{ℓ} .$$

Given a local Pauli measurement Π_{b} there exists a local maximal isotopic I containing b. The trace

$$Tr ( {Π}_{b}^{r} A )$$

is the marginal of

$$Tr ( {Π}_{\text{?}}^{\text{?}} A ) \geq 0 ,$$

$$\text{?} \text{indicates text missing or illegible when filed}$$

hence is non-negative. Assume

$$Tr ( {Π}_{b}^{r} A ) > 0$$

and define

$${A}_{b}^{r} := \frac{{\prod }_{b}^{r} A {\prod }_{b}^{r}}{Tr ( {\prod }_{b}^{r} A )} .$$

We wish to show that

$$Tr ( {Π}_{\text{?}}^{s} {A}_{b}^{r} ) \geq 0$$

$$\text{?} \text{indicates text missing or illegible when filed}$$

so that

$${A}_{b}^{r} ∈ {A}_{n}^{\text{?}} .$$

$$\text{?} \text{indicates text missing or illegible when filed}$$

From the cyclic property of the trace we have that Tr

$$Tr ( {Π}_{\text{?}}^{\text{?}} {A}_{b}^{r} ) = Tr ( {Π}_{\text{?}}^{\text{?}} {Π}_{\text{?}}^{\text{?}} {Π}_{\text{?}}^{\text{?}} A )$$

$$\text{?} \text{indicates text missing or illegible when filed}$$

and using Eq. (B.2) we obtain

$$Tr ( {\prod }_{I}^{s} {A}_{b}^{r} ) = {δ}_{s ( b ) , r} \frac{\vert {〈 b 〉}^{⊥} ⋂ I \vert}{\vert I \vert} Tr ( {\prod }_{I ( b )}^{s * r} A ) . \qquad ( 28 )$$

This expression is either zero or is (up to positive constant) equal to Tr

$$( {\prod }_{I ( b )}^{s * r} A ) ,$$

where

$${\prod }_{I ( b )}^{s * r}$$

is a local stabilizer state by Lemma B.1. Since A∈

$${Λ}_{n}^{ℓ}$$

this expression is always non-negative and thus

$${A}_{b}^{r} ∈ {Λ}_{n}^{ℓ} .$$

This proves Property (1).

For the second property assume Tr

$$( {\prod }_{b}^{r} A ) = 0.$$

For any local isotropic I we have that

$$\begin{matrix}{\sum }_{s} Tr ( {\prod }_{b}^{r} {\prod }_{I}^{s} {\prod }_{b}^{r} A ) & = & {\sum }_{s} {δ}_{s ( b ) , r} \frac{\vert {〈 b 〉}^{⊥} ⋂ I \vert}{\vert I \vert} Tr ( {\prod }_{I ( b )}^{s * r} A ) & ( 29 ) \\ & = & \frac{\vert {〈 b 〉}^{⊥} ⋂ I \vert}{\vert I \vert} {\sum }_{s : s ( b ) = r} Tr ( {\prod }_{I ( b )}^{s * r} A ) & ( 30 ) \\ & = & Tr ( {\prod }_{b}^{r} A ) = 0. & ( 31 )\end{matrix}$$

This implies that

$$Tr ( {Π}_{\text{?}}^{\text{?}} X ) = 0$$

$$\text{?} \text{indicates text missing or illegible when filed}$$

for all value assignments s:I(b)→ [symbol] ₂. Since

$${Π}_{\text{?}}^{\text{?}}$$

$$\text{?} \text{indicates text missing or illegible when filed}$$

can be any local stabilizer state, and since local stabilizer states span Herm( [symbol] ) by Lemma B.2, this implies that

$${Π}_{b}^{r} A {Π}_{b}^{r} = 0.$$

Next we show

$${P}^{ℓ} ⊆ {Λ}_{n}^{ℓ} .$$

### Let

$$A ∈ {P}_{n}^{ℓ} .$$

For any local maximal isotropic subspace I= [symbol] a₁, a₂ . . . , aₙ [symbol] ⊆Eₙ and any value assignment s:I→ [symbol] ₂ we can write the operator

$${Π}_{\text{?}}^{\text{?}}$$

$$\text{?} \text{indicates text missing or illegible when filed}$$

as the product of a product of local Pauli measurements such as

$${Π}_{\text{?}}^{\text{?}} = {Π}_{\text{?}}^{\text{?}} {Π}_{\text{?}}^{\text{?}} {…Π}_{\text{?}}^{\text{?}}$$

$$\text{?} \text{indicates text missing or illegible when filed}$$

where sᵢ=s(aᵢ). Therefore,

$$\begin{matrix}Tr ( {\prod }_{I}^{s} A ) = Tr ( {\prod }_{I}^{s} A {\prod }_{I}^{s} ) \\ = Tr ( {\prod }_{{a}_{1}}^{{s}_{1}} … {\prod }_{{a}_{n}}^{{s}_{n}} A {\prod }_{{a}_{n}}^{{s}_{n}} … {\prod }_{{a}_{1}}^{{s}_{1}} )\end{matrix} .$$

We can change the order of the projectors since I is isotropic. Now there are two possibilities

$$Tr ( {\prod }_{{a}_{n}}^{{s}_{n}} A {\prod }_{{a}_{n}}^{{s}_{n}} ) > 0$$

or it is zero. If it is zero then

$$Tr ( {\prod }_{I}^{s} A ) = 0$$

and if it is greater than zero, let

$${A}_{{a}_{n}}^{{s}_{n}}$$

∈Pₙ. Then, we have

$$Tr ( {\prod }_{I}^{s} A ) = Tr ( {\prod }_{{a}_{1}}^{{s}_{1}} … {\prod }_{{a}_{n - 1}}^{{s}_{n - 1}} {A}_{{a}_{n}}^{{s}_{n}} {\prod }_{{a}_{n - 1}}^{{s}_{n - 1}} … {\prod }_{{a}_{1}}^{{s}_{1}} ) .$$

Since

$${A}_{{a}_{n}}^{{s}_{n}}$$

∈Pₙ, we can repeat this at most n times to get the desired result. If any of the intermediate traces are zero then we have

$$Tr ( {\prod }_{J}^{s} A ) = 0.$$

Otherwise, we have

$$Tr ( {\prod }_{I}^{s} A )$$

is equal to the product of a positive numbers which is positive. Hence

$$Tr ( {\prod }_{I}^{s} A ) \geq 0.$$

[symbol]

### B.3 Proof of Proposition 5.4

We will write

$${p}_{I}^{s}$$

for the probability defined in Eq. (6) where I= [symbol] a₁, . . . , aₙ [symbol] and s:I→ [symbol] ₂ a local value assignment. Given a subspace J⊆I the marginal is defined by

$${p}_{J}^{r} = {\sum }_{s : s \vert J = r} {p}_{I}^{s} .$$

We will simply write pₐ for the marginal over

$$〈 a 〉 and {ϵ}_{a} = {p}_{a}^{0} - {p}_{a}^{1}$$

for the expectation.

Lemma B.3. A non-signaling distribution

$$\{ {p}_{I}^{s} \}$$

is uniquely determined by the expectations {eₐ}, and vice versa.

Proof. Consider the function p:Eₙ→ [symbol] ₂ defined by p=Σ_{a∈E}_{ₙ} eₐδ^{a}. This function is uniquely determined by the family {p|_{I}} of restrictions to local maximal isotropics. The moment formula [31] gives the inverse transformation for going from the distribution

$${\{ {p}_{I}^{s} \}}_{s}$$

to the marginals {eₐ}_{a∈I}.

[symbol]

Proof of Proposition 5.4. The map φ is injective since the local stabilizer states {II_{I}^{s}} span the space of Hermitian operators (Lemma B.2). To see that this map is also surjective we start with a non-signaling distribution p. By Lemma B.3, p is uniquely determined by the expectations {eₐ}. Then we define

$$A = \frac{1}{{2}^{n}} ( + {\sum }_{a ∈ {E}_{n} - \{ 0 \}} {e}_{a} {T}_{a} ) .$$

In fact, this assignment defines the inverse of φ.

[symbol]

### B.4 Proofs in Section 6

Proof of Proposition 6.1. We will use a fundamental result from the theory of GPT's. Firstly, we can define partial trace in the context of GPT's:

$${Tr}_{1} : {A ( {K}_{1} )}^{*} ⊗ {A ( {K}_{2} )}^{*} \to {A ( {K}_{2} )}^{*}$$

where Tr₁=1_{K}_{₁}⊗id. Partial trace on the other factor is similarly defined. These operations induce the partial trace on the general tensor product K₁\tilde{⊗}K₂. We will use [32, Theorem 5.19] which says that if for x∈K₁\tilde{⊗}K₂ it holds that y=Tr₂(x)∈K₁ is a pure state, i.e., an extreme point (vertex), then x=y⊗z for some z∈K₂. Let us consider the maximal tensor product described in Eq. (7) and let A=A_{α}_{₁}⊗A_{α}_{₂}. Assume that we have a convex decomposition

$$A = {\sum }_{α} p ( α ) {A}_{α}$$

in terms of the vertices of

$${Λ}_{{n}_{1} + {n}_{2}}^{ℓ} .$$

Because of the tensor structure we have Tr₁(A)=A_{α}_{₂}, a vertex in Λₙ_{₂}. Note that Tr₁(A_{α})=A_{α}_{₂} for all α with p(α)>0 since

$${A}_{{α}_{2}} = {Tr}_{1} ( A ) = {\sum }_{α} p ( α ) {Tr}_{1} ( {A}_{{α}_{2}} )$$

and A_{α2} is a vertex. By the theorem in stated above this implies that A_{α}=B_{α}⊗A_{α}_{₂} for some B_{α}

$$∈ {Λ}_{{n}_{1}}^{ℓ} .$$

Partial trace applied to the other factor we obtain A_{α}_{₁}=Tr₂(A)=Σ_{α}p(α)B_{α}. This implies that B_{α}=A_{α}_{₁}, and hence A_{α}=A_{α}_{₁}⊗A_{α}_{₂}, for each of these α's. Therefore A is a vertex.

[symbol]

Proof of Proposition 6.4. The trace condition,

$$Tr ( {A}_{Ω}^{γ} ) = 1 ,$$

holds since γ(0)=0. The latter is implied by being a local value assignment. For a local maximal isotropic I, observe that the intersection I′=Ω∩I is also a local isotropic. Then

$$Tr ( {\prod }_{I}^{s} {A}_{Ω}^{γ} ) = Tr ( {\prod }_{{I}^{′}}^{s {\vert}_{{I}^{′}}} {\prod }_{{I}^{′}}^{γ {\vert}_{{I}^{′}}} ) = {δ}_{s , γ} \geq 0.$$

### B.5 Proof of Proposition 7.1

Proof. The formula comes from Lemma A.1. For notational simplicity we will assume that the measurement is performed on the last qubit. We have

$${\prod }_{b}^{r} {A}_{Ω}^{γ} {\prod }_{b}^{r} = ( {\underbrace{\frac{1}{{2}^{n - 1}} {\sum }_{a ∈ Ω ⋂ {E}_{n - 1}} \frac{{( - 1 )}^{γ ( a )} + {( - 1 )}^{γ ( a + b ) + r}}{2} {T}_{a}}}_{\overline{A}} ) ⊗ {\prod }_{b}^{r} .$$

There are two cases to consider:
1. b∈Ω: Ā= [symbol] if γ(b)≠r. Otherwise,

$$\begin{matrix}\overline{A} & = \frac{1}{{2}^{n - 1}} {\sum }_{a ∈ Ω ⋂ {E}_{n - 1}} {( - 1 )}^{γ ( a )} {T}_{a} \\ & = {A}_{Ω ⋂ {E}_{n - 1}}^{γ \vert Ω ⋂ {E}_{n - 1}}\end{matrix} .$$

2 b∉Ω:

$$\begin{matrix}\overline{A} & = \frac{1}{{2}^{n - 1}} ( {\sum }_{a ∈ Ω ⋂ {E}_{n - 1}} \frac{{( - 1 )}^{γ ( a )}}{2} {T}_{a} + {\sum }_{a ∈ b + Ω ⋂ ( b + {E}_{n - 1} )} \frac{{( - 1 )}^{γ ( a + b ) + r}}{2} {T}_{a} ) \\ & = \frac{1}{2} {A}_{{Ω}_{b}}^{{γ}_{b}^{r}}\end{matrix} ,$$

### Interpretation of Terms

Unless the context clearly requires otherwise, throughout the description and the claims:
“in particular” means “for example” or “optionally”;
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms;
words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being “in particular” or present in “some embodiments” or in an “aspect”. Such features are not mandatory in all embodiments and may not be present in all embodiments. Embodiments of the invention may include zero, any one or any combination of two or more of such features. All possible combinations of such features are contemplated by this disclosure even where such features are shown in different drawings and/or described in different sections, sentences or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

While the foregoing is directed to embodiments of the disclosure, other and further embodiments of the disclosure may be devised without departing from the basic scope thereof, and the scope thereof is determined by the claims that follow.

1. A method of simulating a measurement-based quantum computation comprising an application of a sequence of J≥1 steps of Pauli measurements to an entangled resource state of a plurality of n qudits on a classical computer (10), the qudits being quantum mechanical d-level systems, d≥2, the method comprising use of a computational key that is indicative of at least one initial sample from a probability distribution that is associated with the resource state and is defined on an initial set of operators of an initial polytope of trace-one Hermitian operators on a Hilbert space associated with the plurality of qudits, wherein
the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

2. The method according to claim 1, wherein the qudits are qubits.

3. The method according to claim 1, wherein the resource state is a magic Cluster state described by a state parameter specifying a graph of n vertices, each being associated with one qudit, and a plurality of edges, and a subset of the vertices, the resource state having a state vector representation in which a product state of the n qudits, those of which correspond to the vertices of the subset of vertices, are in a magic state, is entangled by an entangling operation specified by the edges of the graph.

4. The method according to claim 1, wherein the method comprises a simulation of the application of the J steps of Pauli measurements by a corresponding sequence of J update maps, wherein starting from the at least one initial sample of the computational key as an input of a first update map of the sequence of update maps, an output of a preceding update map is a basis of an input of a subsequent update map, wherein the output of each map is indicative of an operator of an output polytope which is a local nₒᵤₜ-qudit polytope specified by an output number nₒᵤₜ of qudits which is equal or less than the number n of qudits.

5. The method according to claim 1, wherein the Pauli measurements are single-qudit Pauli measurements.

6. The method according to claim 1, wherein the initial set of operators comprises at least one extreme point of the initial polytope.

7. The method according to claim 1, wherein the initial set of operators comprises at least one operator which is a locally closed operator defined by the property that its expectation values with respect to a locally closed subset of Pauli operators are the d-th roots of unity, and zero otherwise, wherein a locally closed subset is a subset of Pauli operators such that the product of any pair of locally commuting Pauli operators, i.e., those operators for which all tensor factors commute, belongs to the set.

8. The method according to claim 1, wherein the initial set of operators comprises at least one operator which is a tensor product of k>1 operators, each operator being an operator of a local n-qudit polytope such that n₁+n₂+ . . . +nₖ=n.

9. The method according to claim 7, wherein the tensor factors are locally closed operators, which are either an extreme point of a local single-qudit polytope or, in the case of qubits, a max-weight nᵢ-qubit type defined by the property that its expectation values with respect to those Pauli operators for which each tensor factor is non-trivial, is +1 or −1, and zero otherwise.

10. The method according to claim 4, wherein the output is indicative of an extreme point of the output polytope.

11. The method according to claim 4, wherein starting from the at least one initial sample the output of each map is indicative of a sample from an update map probability distribution associated with the corresponding Pauli measurement, the update map probability distribution being defined on a set of operators of a local nᵤₘ-qudit polytope specified by an update map number nᵤₘ of qudits which is smaller than an input number nᵢₙ of qudits specifying an input polytope of the update map.

12. The method according to claim 4, wherein at least one Pauli measurement is a non-destructive measurement and the output polytope of the corresponding update map corresponds to the input polytope of the update map.

13. The method according to claim 4, wherein at least one Pauli measurement is a destructive single-qudit measurement and the output number nₒᵤₜ specifying the output polytope of the corresponding update map is one less than the input number nᵢₙ specifying the input polytope of the corresponding update map.

14. The method according to claim 1, wherein the probability distribution is defined by weights of a representation of the resource state by a weighted sum of the operators of the initial set of operators.

15. The method according to claim 1, the method comprising the generation of the computational key.

16. The method according to claim 15, wherein said generation is by a key generation computer which comprises a classical processor or a quantum processor.

17. The method according to claim 15, wherein the resource state has a classical description in terms of a structure parameter and wherein the generation of the computational key is on the basis of the structure parameter.

18. The method according to claim 17, wherein the resource state is a magic Cluster state described by a state parameter specifying a graph of n vertices, each being associated with one qudit, and a plurality of edges, and a subset of the vertices, the resource state having a state vector representation in which a product state of the n qudits, those of which correspond to the vertices of the subset of vertices, are in a magic state, is entangled by an entangling operation specified by the edges of the graph, and the structure parameter comprises the state parameter.

19. A method for generating a computational key by a key generation computer, the computational key being configured for simulating a measurement-based quantum computation comprising an application of a sequence of J≥1 steps of Pauli measurements to an entangled resource state of a plurality of n qudits on a classical computer, the qudits being quantum mechanical d-level systems, d≥2, the method comprising:
representing the resource state by a weighted sum of an initial set of operators of an initial polytope of trace-one Hermitian operators on a Hilbert space associated with the plurality of qudits:
defining a probability distribution over the initial set of operators by the weights of the representation;
generating the computational key on the basis of the probability distribution such that it is indicative of at least one initial sample from the probability distribution, wherein
the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

20. A computing system for simulating a measurement-based quantum computation comprising an application of a sequence of J≥1 steps of Pauli measurements to an entangled resource state of a plurality of n qudits, the qudits being quantum mechanical d-level systems, d≥2, the system comprising a classical computer and a key generation computer, wherein
the key generation computer is configured to generate a computational key that is indicative of at least one initial sample from a probability distribution that is associated with the resource state and is defined on an initial set of operators of an initial polytope of trace-one Hermitian operators on a Hilbert space associated with the plurality of qudits, and to provide the computational key to the classical computer,
the classical computer is configured to receive the computational key and to simulate the measurement-based quantum computation by use of the computational key, wherein
the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

21. A computer program product for simulating a measurement-based quantum computation on a classical computer, wherein the computer program product includes instructions, which, when the program is carried out by a classical computer, cause the classical computer to:
receive a classical description of the measurement-based quantum computation, the classical description comprising a classical description of an entangled resource state of a plurality of n qudits, the qudits being quantum mechanical d-level systems, d≥2;
simulate the measurement-based quantum computation, wherein
the simulation comprises use of a computational key that is indicative of at least one initial sample from a probability distribution that is associated with the resource state and is defined on an initial set of operators of an initial polytope of trace-one Hermitian operators on a Hilbert space associated with the plurality of qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

22. A computer-readable storage medium comprising instructions which, when executed by a classical computer, cause the classical computer to:
receive a classical description of a measurement-based quantum computation, the classical description comprising a classical description of an entangled resource state of a plurality of n qudits, the qudits being quantum mechanical d-level systems, d≥2;
simulate the measurement-based quantum computation, wherein the simulation comprises use of a computational key that is indicative of at least one initial sample from a probability distribution that is associated with the resource state and is defined on an initial set of operators of an initial polytope of trace-one Hermitian operators on a Hilbert space associated with the plurality of qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors.

23. A computer program product for generating a computational key which is configured for simulating a measurement-based quantum computation on a classical computer, wherein the computer program includes instructions which, when the program is carried out by a key generation computer, cause the key generation computer to:
receive a classical description of an n-qudit resource state of the measurement-based quantum computation, the qudits being quantum mechanical d-level systems, d≥2;
represent the resource state by a weighted sum of an initial set of operators of an initial polytope of trace-one Hermitian operators on a Hilbert space associated with the n qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors;
define a probability distribution over the initial set of operators by the weights of the representation;
generate the computational key on the basis of the probability distribution such that it is indicative of at least one initial sample from the probability distribution.

24. A computer-readable storage medium comprising instructions which, when executed by a key generation computer, cause the key generation computer to:
receive a classical description of an n-qudit resource state of a measurement-based quantum computation, the qudits being quantum mechanical d-level systems, d≥2;
represent the resource state by a weighted sum of an initial set of operators of an initial polytope of trace-one Hermitian operators on a Hilbert space associated with the n qudits, wherein the initial polytope is a local n-qudit polytope specified by the number n of qudits and defined as a set of those trace-one Hermitian operators on the Hilbert space associated with the plurality of n qudits having the property that for each local stabilizer state of the plurality of qudits a trace of a product of the Hermitian operator and a density operator of the local stabilizer state is equal to or larger than zero, wherein the local stabilizer states are those states which are generated by applying a unitary operation to a computational zero-state of the plurality of qudits, the unitary operation being an element of a group generated by a local Clifford group that is generated by the single-qudit Clifford unitaries acting on each tensor factor and unitaries that permute the tensor factors;
define a probability distribution over the initial set of operators by the weights of the representation;
generate the computational key on the basis of the probability distribution such that it is indicative of at least one initial sample from the probability distribution.
